(19) United States
(12) Patent Application Publication
(10) Pub. No.: US 2003/0223523 A1
(43) Pub. Date: Dec. 4, 2003

(54) Signal-controlling apparatus and image-forming apparatus

(76) Inventor: Kouichi Takaki, Tokyo (JP)

Correspondence Address: CANTOR COLBURN LLP, 55 Griffin Road South, Bloomfield, CT, 06002, US

(21) Appl. No.: 10/444,574

(22) Filed: May 23, 2003

(30) Foreign Application Priority Data
May 31, 2002 (JP) JP2002-159254
Jul. 12, 2002 (JP) JP2002-204142

(51) Int. Cl. H04L 7/00

(52) U.S. Cl. 375/354

(57) ABSTRACT

There is described signal-controlling apparatus coupled to each other through serial interfaces for bilaterally communicating data with synchronized clock signals. The apparatus includes signal-processing circuits, each of which includes a clock-generating section, a data communication line through which data signals are communicated between the signal-processing circuits, and a reference pulse communication line through which reference pulses are transmitted from a master signal-processing circuit to a slave signal-processing circuit. In a measuring time, the master signal-processing circuit transmits the reference pulses to the slave signal-processing circuit at intervals of a predetermined time period, and the slave signal-processing circuit receives the reference pulse to find a frequency deviation of clock signals by measuring an interval between the reference pulses with the clock signals. In the operating time after the measuring time, the slave signal-processing circuit adjusts the frequency deviation of clock signals, based on a result found in the measuring time.

### BACKGROUND OF THE INVENTION

The present invention relates to signal-controlling apparatus and/or image-forming apparatus, in which a plurality of signal-controlling means, controlled by data signals, clock signals and either reference pulses or load signals, are provided, and which are coupled to each other through a serial interface for bilaterally communicating data in a state of synchronizing with clock signals, and specifically relates to an improvement of the serial data transmission between the signal-controlling means.

There has been introduced in the market a signal-controlling apparatus, such as an image-processing apparatus, an image-forming apparatus, etc., having a plurality of signal-processing circuits, each of which is provided with a clock-generating section.

In such the signal-controlling apparatus, to insure a proper image-processing operation and data transactions, the plurality of signal-processing circuits should be driven by clock signals having the same frequency and phase.

Incidentally, in regard to an arrangement of the plurality of signal-processing circuits, there would be various cases, such as a case in which the signal-processing circuits are distributed among plural apparatus being different to each other, a case in which the signal-processing circuits are arranged within the same apparatus, a case in which the signal-processing circuits are arranged within the same circuit board of the same apparatus, etc.

Concretely speaking, a plurality of signal-processing circuits, which are driven by the clock signals having the same frequency and phase so as to perform an image-processing in the copier, each of a plurality of copiers and their internal signal-processing circuits when the copiers connected each other are operated in tandem (a tandem operating mode), etc., can be categorized in the abovementioned examples.

In order to drive the signal-processing circuits mentioned above with the clock signals having the same frequency and phase, the signal-processing circuits should be coupled to each other with data communicating lines for communicating the data and clock pulse lines for supplying the clock signals.

In other words, the clock pulses should be transmitted to each other in parallel with the data communication between them. Further, in addition to the above, a reference pulse signal indicating a transmittance timing of the data is necessary, and therefore, the data, the clock signals and the reference pulse signal should be respectively transmitted through each of three signal lines.

In the above configuration, since each of the clock pulse lines is coupled to each other between each pair of the plurality of signal-processing circuits, there has been a problem that electromagnetic radiation noises, having the clock-frequency and higher-harmonic frequencies, are radiated from the clock pulse lines. Recently, the clock-frequency has been increasingly higher than ever, and accordingly, such the problem of influences, caused by the electro-magnetic radiation noises, becomes serious and cannot be ignored.

Further, when an oscillator is provided with each of a plurality of signal-processing circuits to generate the clock signals having the same frequency between them, slight frequency errors are generated between them even if a crystal oscillating element is employed for the oscillator. Accordingly, even if they are synchronized with each other at certain timing, slight amounts of phase deviations between them will be gradually accumulated to large amounts, resulting in an inability of synchronized communication between them.

### SUMMARY OF THE INVENTION

To overcome the abovementioned drawbacks in conventional signal-controlling apparatus, it is a first object of the present invention to provide signal-controlling apparatus and image-forming apparatus, in which a plurality of signal-processing circuits are controlled by data signals, clock signals and reference pulses, and which are coupled to each other through a serial interface for bilaterally communicating data in a state of synchronizing with clock signals, and which make it possible to perform serial data transmitting operations between the signal-processing circuits without causing the problems of the electromagnetic radiation noises and the frequency deviation of the clock signals.

Further, it is a second object of the present invention to provide signal-controlling apparatus and image-forming apparatus, in which a plurality of signal-processing circuits are controlled by data signals, clock signals and load signals, and which are coupled to each other through a serial interface for bilaterally communicating data in a state of synchronizing with clock signals, and which make it possible to perform serial data transmitting operations between the signal-processing circuits without causing the problems of the electro-magnetic radiation noises and the frequency deviation of the clock signals.

Accordingly, to overcome the cited shortcomings, the abovementioned object of the present invention can be attained by image-recording apparatus described as follow.

(1) A signal-controlling apparatus, which is coupled to another signal-controlling apparatus through a synchronized serial interface for bilaterally communicating data signals in a state synchronized with clock signals, the signal-controlling apparatus comprising: a plurality of signal-processing circuits, each of which includes a clock-generating section to generate the clock signals; a data communication line through which the data signals are bilaterally communicated between the plurality of signal-processing circuits; and a reference pulse communication line through which reference pulses are transmitted from a master signal-processing circuit, being anyone of the plurality of signal-processing circuits, to a slave signal-processing circuit, being another one of the plurality of signal-processing circuits; wherein, in a measuring time prior to an operating time, the master signal-processing circuit transmits the reference pulses to the slave signal-processing circuit at intervals of a predetermined time period; and wherein, in the measuring time, the slave signal-processing circuit receives the reference pulse to find a frequency deviation of clock signals, generated in the clock-generating section, by measuring an interval between the reference pulses with clock signals generated in the clock-generating section, and, in the operating time after the measuring time, the slave signal-processing circuit adjusts the frequency deviation of clock signals, based on a result found in the measuring time.

(2) The signal-controlling apparatus of item 1, wherein the clock-generating section, provided in the slave signal-processing circuit, comprises: an oscillator to generate original-oscillation signals, having substantially a same frequency as that of the clock signals generated in the master signal-processing circuit; a delay chain section, including a plurality of delay stages cascaded in a chain, to generate a plurality of delayed signals by delaying the original-oscillation signals outputted from the oscillator in slightly different delay times, and each of the plurality of delayed signals being outputted from each of the plurality of delay stages; a synchronized-signal detecting section to detect a number of delay stages, which outputs a delayed signal synchronized with a first reference pulse, being one of the reference pulses, and another number of delay stages, which outputs a delayed signal synchronized with a second reference pulse, received next to the first reference pulse; and a correction-calculating section to count the original-oscillation signals occurring between the first reference pulse and the second reference pulse in a unit of one pulse of the clock signals, and to measure a partial duration time less than one period of the clock signals by referring a result detected by the synchronized-signal detecting section, so as to measure the frequency deviation of clock signals, generated in the clock-generating section provided in the slave signal-processing circuit, in an accuracy of less than one period of the clock signals.

(3) The signal-controlling apparatus of item 2, wherein the clock-generating section, provided in the slave signal-processing circuit, further comprises: a selector controlling section (hereinafter, also referred to as a synchronized switching section) to control a selecting operation of the delayed signals outputted by the delay chain section; and a selector to select a specific delayed signal out of the delayed signals inputted from the delay chain section, based on a command signal outputted from the selector controlling section; wherein the correction-calculating section finds a adjusting coefficient for adjusting the frequency deviation of the clock signals by comparing a result, of measuring a number of clock signals included in a time between the first reference pulse and the second reference pulse in the accuracy of less than one period of the clock signals, with the predetermined time period between the reference pulses; and wherein, in the operating time, the selector controlling section controls the selecting operation of the delayed signals, corresponding to the adjusting coefficient and the result detected by the synchronized-signal detecting section, so as to adjust the frequency deviation of the clock signals for every clock pulse in an accuracy of less than one period of the clock signals.

(4) The signal-controlling apparatus of item 3, wherein each of sections included in the signal-controlling apparatus is composed of digital circuits.

(5) The signal-controlling apparatus of item 3, wherein each of sections included in the signal-controlling apparatus is composed of digital circuits and the signal-controlling apparatus includes a CPU (Central Processing Unit) serving as a controlling section.

(6) An image-forming apparatus, which is coupled to another image-forming apparatus through a synchronized serial interface for bilaterally communicating data signals in a state synchronized with clock signals, the image-forming apparatus comprising: a plurality of signal-processing circuits, each of which includes a clock-generating section to generate the clock signals; a data communication line through which the data signals are bilaterally communicated between the plurality of signal-processing circuits; and a reference pulse communication line through which reference pulses are transmitted from a master signal-processing circuit, being anyone of the plurality of signal-processing circuits, to a slave signal-processing circuit, being another one of the plurality of signal-processing circuits; wherein, in a measuring time prior to an operating time, the master signal-processing circuit transmits the reference pulses to the slave signal-processing circuit at intervals of a predetermined time period; and wherein, in the measuring time, the slave signal-processing circuit receives the reference pulse to find a frequency deviation of clock signals, generated in the clock-generating section, by measuring an interval between the reference pulses with clock signals generated in the clock-generating section, and, in the operating time after the measuring time, the slave signal-processing circuit adjusts the frequency deviation of clock signals, based on a result found in the measuring time.

(7) The image-forming apparatus of item 6, wherein the clock-generating section, provided in the slave signal-processing circuit, comprises: an oscillator to generate original-oscillation signals, having substantially a same frequency as that of the clock signals generated in the master signal-processing circuit; a delay chain section, including a plurality of delay stages cascaded in a chain, to generate a plurality of delayed signals by delaying the original-oscillation signals outputted from the oscillator in slightly different delay times, and each of the plurality of delayed signals being outputted from each of the plurality of delay stages; a synchronized-signal detecting section to detect a number of delay stages, which outputs a delayed signal synchronized with a first reference pulse, being one of the reference pulses, and another number of delay stages, which outputs a delayed signal synchronized with a second reference pulse, received next to the first reference pulse; and a correction-calculating section to count the original-oscillation signals occurring between the first reference pulse and the second reference pulse in a unit of one pulse of the clock signals, and to measure a partial duration time less than one period of the clock signals by referring a result detected by the synchronized-signal detecting section, so as to measure the frequency deviation of clock signals, generated in the clock-generating section provided in the slave signal-processing circuit, in an accuracy of less than one period of the clock signals.

(8) The image-forming apparatus of item 7, wherein the clock-generating section, provided in the slave signal-processing circuit, further comprises: a selector controlling section (hereinafter, also referred to as a synchronized switching section) to control a selecting operation of the delayed signals outputted by the delay chain section; and a selector to select a specific delayed signal out of the delayed signals inputted from the delay chain section, based on a command signal outputted from the selector controlling section; wherein the correction-calculating section finds a adjusting coefficient for adjusting the frequency deviation of the clock signals by comparing a result, of measuring a number of clock signals included in a time between the first reference pulse and the second reference pulse in the accuracy of less than one period of the clock signals, with the predetermined time period between the reference pulses; and wherein, in the operating time, the selector controlling section controls the selecting operation of the delayed signals, corresponding to the adjusting coefficient and the result detected by the synchronized-signal detecting section, so as to adjust the frequency deviation of the clock signals for every clock pulse in an accuracy of less than one period of the clock signals.

(9) A signal-controlling apparatus, which is coupled to another signal-controlling apparatus through a serial interface for bilaterally communicating data signals in a state synchronized with clock signals, the signal-controlling apparatus comprising: a plurality of signal-processing circuits, each of which includes a clock-generating section to generate the clock signals; a data communication line through which the data signals are bilaterally communicated between the plurality of signal-processing circuits; and a load signal communication line through which load signals are transmitted from a master signal-processing circuit, being anyone of the plurality of signal-processing circuits, to a slave signal-processing circuit, being another one of the plurality of signal-processing circuits; wherein, in the slave signal-processing circuit, both a data transmitting/receiving operation and a synchronizing operation for the clock-generating section are conducted on the basis of the load signals transmitted from the master signal-processing circuit.

(10) The signal-controlling apparatus of item 9, wherein the load signals are periodically transmitted at intervals of a predetermined time period.

(11) The signal-controlling apparatus of item 9, wherein the clock-generating section, provided in the slave signal-processing circuit, comprises: an oscillator to generate original-oscillation signals, having substantially a same frequency as that of the clock signals generated in the master signal-processing circuit; a delay chain section, including a plurality of delay stages cascaded in a chain, to generate a plurality of delayed signals by delaying the original-oscillation signals outputted from the oscillator in slightly different delay times, and each of the plurality of delayed signals being outputted from each of the plurality of delay stages; a synchronized-signal detecting section to detect a delayed signal synchronized with the load signals; and a selector to select a specific delayed signal out of the delayed signals inputted from the delay chain section, based on a command signal outputted from the selector controlling section.

(12) The signal-controlling apparatus of item 9, wherein each of sections included in the signal-controlling apparatus is composed of digital circuits.

(13) The signal-controlling apparatus of item 11, further comprising: a selector controlling section (hereinafter, also referred to as a synchronized switching section) to perform an arithmetic processing for fine adjustments when selecting the specific delayed signal out of the delayed signals inputted from the delay chain section.

(14) The signal-controlling apparatus of item 11, further comprising: a storing section to store setting data for the synchronizing operation; and a controlling section to control each of sections included in the signal-controlling apparatus by referring to the setting data stored in the storing section.

(15) The signal-controlling apparatus of item 11, further comprising: a data communicating section to receive setting data for the synchronizing operation from an external apparatus; and a controlling section to control each of sections included in the signal-controlling apparatus by referring to the setting data received through the data communicating section.

(16) The signal-controlling apparatus of item 11, further comprising: a data inputting terminal to input setting data for the synchronizing operation; and a controlling section to control each of sections included in the signal-controlling apparatus by referring to the setting data inputted through the data inputting terminal.

(17) An image-forming apparatus, which is coupled to another image-forming apparatus through a serial interface for bilaterally communicating data signals in a state synchronized with clock signals, the image-forming apparatus comprising: a plurality of signal-processing circuits, each of which includes a clock-generating section to generate the clock signals; a data communication line through which the data signals are bilaterally communicated between the plurality of signal-processing circuits; and a load signal communication line through which load signals are transmitted from a master signal-processing circuit, being anyone of the plurality of signal-processing circuits, to a slave signal-processing circuit, being another one of the plurality of signal-processing circuits; wherein, in the slave signal-processing circuit, both a data transmitting/receiving operation and a synchronizing operation for the clock-generating section are conducted on the basis of the load signals transmitted from the master signal-processing circuit.

(18) The image-forming apparatus of item 17, wherein the load signals are periodically transmitted at intervals of a predetermined time period.

(19) The image-forming apparatus of item 17, wherein the clock-generating section, provided in the slave signal-processing circuit, comprises: an oscillator to generate original-oscillation signals, having substantially a same frequency as that of the clock signals generated in the master signal-processing circuit; a delay chain section, including a plurality of delay stages cascaded in a chain, to generate a plurality of delayed signals by delaying the original-oscillation signals outputted from the oscillator in slightly different delay times, and each of the plurality of delayed signals being outputted from each of the plurality of delay stages; a synchronized-signal detecting section to detect a delayed signal synchronized with the load signals; and a selector to select a specific delayed signal out of the delayed signals inputted from the delay chain section, based on a command signal outputted from the selector controlling section.

(20) The image-forming apparatus of item 17, wherein each of sections included in the signal-controlling apparatus is composed of digital circuits.

Further, to overcome the abovementioned problems, other signal-controlling apparatus and image-forming apparatus, embodied in the present invention, will be described as follow:

(21) A signal-controlling apparatus, characterized in that,

in the signal-controlling apparatus, which comprises a plurality of signal-processing circuits, each having a clock-signal generating section and controlled by the data signals, clock signals and reference pulses, and which are coupled to each other through a synchronized serial interface for bilaterally communicating the data signals in a state synchronized with clock signals,

the plurality of signal-processing circuits are coupled to each other with a data communication line through which the data signals are bilaterally communicated between the plurality of signal-processing circuits and a reference pulse communication line through which reference pulses are transmitted, and anyone of the plurality of signal-processing circuits acts as a master circuit, while others act as slave circuits,

and, in a measuring time prior to an operating time, the master signal-processing circuit transmits the reference pulse to the slave signal-processing circuit at intervals of a predetermined time period,

and, in the measuring time, the slave signal-processing circuit receives the reference pulse to measure a frequency deviation of clock signals, generated in said clock-generating section, by measuring the reference pulse with the clock signals from the clock-signal generating section, and, in the operating time after the measuring time, the slave signal-processing circuit adjusts the frequency deviation of clock signals, based on the measuring result made in the measuring time.

According to the above invention, when the plurality of signal-processing circuits are controlled by the data signals, clock signals and reference pulses and are coupled to each other through the synchronized serial interface for bilaterally communicating the data signals in the state synchronized with the clock signals, the plurality of signal-processing circuits are coupled to each other with the data communication line through which the data signals are bilaterally communicated between the plurality of signal-processing circuits and the reference pulse communication line through which the reference pulses are transmitted, and anyone of the plurality of signal-processing circuits acts as a master circuit, while others act as slave circuits.

At first, in the measuring time prior to the operating time, the master signal-processing circuit transmits the reference pulse to the slave signal-processing circuit at intervals of the predetermined time period, and, in the measuring time, the slave signal-processing circuit receives the reference pulse to measure a frequency deviation of clock signals, generated in said clock-generating section, by measuring the reference pulse with the clock signals from the clock-signal generating section. Then, in the operating time after the measuring time, the slave signal-processing circuit adjusts the frequency deviation of clock signals, based on the measuring result made in the measuring time. Through the abovementioned process, the clock signals of the slave signal-processing circuits are synchronized with that of the master signal-processing circuit.

As a result, clock-signal transmitting lines and the transmission of clock signals between signal-processing circuits are eliminated, and therefore, the problem of electro-magnetic radiation is solved, and further, the problem of the frequency deviation of clock signals is also solved by employing the reference pulse.

In other words, since the operation for adjusting the frequency deviation of clock signals are performed in the measuring time without really transmitting the clock signals, it becomes possible to perform the serial data transmitting operation in the operating time without causing the problems of electromagnetic radiation and the frequency deviation of clock signals.

(22) The signal-controlling apparatus, described in item 21, characterized in that,

the clock-generating section, provided in the slave signal-processing circuit, includes a delay chain section that generates a plurality of delayed-clock pulses by delaying a reference oscillation signal in slightly different delay times, a synchronized-signal detecting section that detects a number of delay stages, being a number of delayed signal synchronized with the reference oscillation signal, and a number of synchronized delay-stages, being a number of stages between plural delayed signals synchronized with the reference oscillation signal, and a correction-calculating section that counts the clock signals in a unit of one clock pulse and measures the time interval smaller than one clock pulse by referring the result detected by the synchronized-signal detecting section, in order to measure the frequency deviation of clock signals generated in the clock-generating section in an accuracy of smaller than one clock pulse during the measuring time.

According to the above invention, the clock-generating section, provided in the slave signal-processing circuit, generates a plurality of delayed-clock pulses by delaying a reference oscillation signal in slightly different delay times, and detects a number of delay stages, being a number of delayed signal synchronized with the reference oscillation signal, and a number of synchronized delay-stages, being a number of stages between plural delayed signals synchronized with the reference oscillation signal. Further, in the clock-generating section, the time interval between the reference pulses is measured by counting the clock signals in a unit of one clock pulse and measuring the time interval smaller than one clock pulse by referring the number of delay stages and the number of synchronized delay-stages, in order to measure the frequency deviation of clock signals generated in the clock-generating section in an accuracy of smaller than one clock pulse during the measuring time.

Accordingly, by performing the measurement of the frequency deviation of the clock signals in an accuracy of smaller than one clock pulse by employing the digital delay adjusting method in the measuring time without causing the problems of electro-magnetic radiation in the signal-processing circuits controlled by the data signals, the clock signals and the reference pulses, it becomes possible to perform the serial data transmitting operation without causing the problem of the frequency deviation even in the operating time.

(23) The signal-controlling apparatus, described in item 22, characterized in that,

the slave signal-processing circuit is provided with a selection controlling section that controls selection of the delayed signals from the delay chain section, and a selecting section that select a specific delayed signal out of the delayed signals from the delay chain section, based on a command signal from the selection controlling section to output the specific delayed signal as a clock signal, and

the correction-calculating section finds an adjusting coefficient for adjusting the frequency deviation of the clock signals by comparing the result of measuring the time interval between the reference pulses in an accuracy of smaller than one clock pulse during the measuring time with the predetermined time period between the reference pulses, and

the selection controlling section controls the selection of the delayed signals corresponding to the detected result of the synchronized-signal detecting section and the adjusting coefficient, in order to adjust the frequency deviation of the clock signals for every clock pulse in an accuracy of less than one period of the clock signals in the operating time.

According to the above invention, by comparing the result of measuring the time interval between the reference pulses in item 22 in an accuracy of smaller than one clock pulse during the measuring time with the predetermined time period between the reference pulses, the adjusting coefficient for adjusting the frequency deviation of the clock signals is found, so as to control the selection of the delayed signals in the operating time.

Concretely speaking, by performing the measurement of the frequency deviation of the clock signals in an accuracy of smaller than one clock pulse in the measuring time and performing the deviation adjustment for every clock signal in an accuracy of smaller than one clock pulse in the operating time by employing the digital delay adjusting method without causing the problems of electromagnetic radiation in the signal-processing circuits controlled by the data signals, the clock signals and the reference pulses, it becomes possible to perform the serial data transmitting operation without causing the problem of the frequency deviation of the clock signals.

(24) The signal-controlling apparatus, described in anyone of items 21-23, characterized in that each of sections included in the signal-controlling apparatus is composed of digital circuits.

According to the above invention, by composing each of signal-processing circuits from digital circuits, it is possible to structure a plurality of signal-processing circuits within a low cost. Further, by employing the digital circuits, it becomes possible to integrate the whole configuration of the circuits into one tip IC, resulting in shortening of the wirings, easiness of the controlling operation, and further, improvement of the accuracy.

(25) The signal-controlling apparatus, described in anyone of items 21-23, characterized in that each of sections included in the signal-controlling apparatus is composed of digital circuits and the signal-controlling apparatus includes a CPU (Central Processing Unit) serving as a controlling section.

According to the above invention, by composing each section from digital circuits and controlling them with CPU, it is possible to structure a plurality of signal-processing circuits within a low cost. Further, by employing the digital circuits, it becomes possible to integrate the whole configuration of the sections into one tip IC, resulting in shortening of the wirings, easiness of the controlling operation, and further, improvement of the accuracy.

(26) An image-forming apparatus, characterized in that,

in the image-forming apparatus, which comprises a plurality of signal-processing circuits, each having a clock-signal generating section and controlled by the data signals, clock signals and reference pulses, and which are coupled to each other through a synchronized serial interface for bilaterally communicating the data signals in a state synchronized with clock signals,

the plurality of signal-processing circuits are coupled to each other with a data communication line through which the data signals are bilaterally communicated between the plurality of signal-processing circuits and a reference pulse communication line through which reference pulses are transmitted, and anyone of the plurality of signal-processing circuits acts as a master circuit, while others act as slave circuits,

and, in a measuring time prior to an operating time, the master signal-processing circuit transmits the reference pulse to the slave signal-processing circuit at intervals of a predetermined time period,

and, in the measuring time, the slave signal-processing circuit receives the reference pulse to measure a frequency deviation of clock signals, generated in said clock-generating section, by measuring the reference pulse with the clock signals from the clock-signal generating section, and, in the operating time after the measuring time, the slave signal-processing circuit adjusts the frequency deviation of clock signals, based on the measuring result made in the measuring time.

According to the image-forming apparatus embodied in the above invention, when the plurality of signal-processing circuits are controlled by the data signals, clock signals and reference pulses and are coupled to each other through the synchronized serial interface for bilaterally communicating the data signals in the state synchronized with the clock signals, the plurality of signal-processing circuits are coupled to each other with the data communication line through which the data signals are bilaterally communicated between the plurality of signal-processing circuits and the reference pulse communication line through which the reference pulses are transmitted, and anyone of the plurality of signal-processing circuits acts as a master circuit, while others act as slave circuits.

At first, in the measuring time prior to the operating time, the master signal-processing circuit transmits the reference pulse to the slave signal-processing circuit at intervals of the predetermined time period, and, in the measuring time, the slave signal-processing circuit receives the reference pulse to measure a frequency deviation of clock signals, generated in said clock-generating section, by measuring the reference pulse with the clock signals from the clock-signal generating section. Then, in the operating time after the measuring time, the slave signal-processing circuit adjusts the frequency deviation of clock signals, based on the measuring result made in the measuring time. Through the abovementioned process, the clock signals of the slave signal-processing circuits are synchronized with that of the master signal-processing circuit.

As a result, clock-signal transmitting lines and the transmission of clock signals between signal-processing circuits are eliminated, and therefore, the problem of electromagnetic radiation is solved, and further, the problem of the frequency deviation of clock signals is also solved by employing the reference pulse.

In other words, since the image-forming apparatus performs the operation for adjusting the frequency deviation of clock signals in the measuring time without really transmitting/receiving the clock signals, it becomes possible to perform the serial data transmitting operation in the operating time without causing the problems of electromagnetic radiation and the frequency deviation of clock signals.

(27) A signal-controlling apparatus, characterized in that,

in the signal-controlling apparatus, which comprises a plurality of signal-processing means, each having a clock-signal generating section and controlled by the data signals, clock signals and load signals, and which are coupled to each other through a synchronized serial interface for bilaterally communicating the data signals in a state synchronized with clock signals,

the plurality of signal-processing means are coupled to each other with a data communication line through which the data signals are bilaterally communicated between the plurality of signal-processing means and a load-signal communication line through which load signals are transmitted, and

anyone of the plurality of signal-processing means transmits the load signals to other signal-processing means, while the others control data transmitting/receiving operations and perform synchronizing operations in the clock-signal generating sections, based on the load signals.

According to the above invention, when the plurality of signal-processing means are controlled by the data signals, clock signals and load signals, and are coupled to each other through the synchronized serial interface for bilaterally communicating the data signals in the state synchronized with the clock signals, the plurality of signal-processing means are coupled to each other with the data communication line through which the data signals are bilaterally communicated between the plurality of signal-processing means and the load signals communication line through which the load signals are transmitted, and anyone of the plurality of signal-processing means transmits the load signals to other signal-processing means, while the others control data transmitting/receiving operations and perform synchronizing operations in the clock-signal generating sections, based on the load signals.

As a result, clock-signal transmitting lines and the transmission of clock signals between signal-processing means are eliminated, and therefore, the problem of electromagnetic radiation is solved, and further, the problem of the frequency deviation of clock signals is also solved by employing the load signals for the synchronizing operations.

(28) The signal-controlling apparatus, described in item 27, characterized in that

the signal-processing means are signal-processing circuits, and

the controlling of the data transmitting/receiving operations and synchronizing operations in the clock-signal generating sections are performed between the signal-processing circuits, based on the load signals.

According to the above invention, the signal-processing means cited in item 27 are the signal-processing circuits, so that the controlling of the data transmitting/receiving operations and synchronizing operations in the clock-signal generating sections are performed between the signal-processing circuits, based on the load signals.

As a result, the continuous transmission of clock signals between signal-processing circuits are eliminated, and therefore, the problem of electromagnetic radiation is solved, and further, the problem of the frequency deviation of clock signals is also solved by employing the load signals for the synchronizing operations.

(29) The signal-controlling apparatus, described in item 27, characterized in that

the signal-processing means are signal-processing circuit boards, and the controlling of the data transmitting/receiving operations and synchronizing operations in the clock-signal generating sections are performed between the signal-processing circuit boards, based on the load signals.

According to the above invention, the signal-processing means cited in item 27 are the signal-processing circuit boards, so that the controlling of the data transmitting/receiving operations and synchronizing operations in the clock-signal generating sections are performed between the signal-processing circuit boards, based on the load signals.

As a result, the continuous transmission of clock signals between signal-processing circuits are eliminated, and therefore, the problem of electro-magnetic radiation is solved, and further, the problem of the frequency deviation of clock signals is also solved by employing the load signals for the synchronizing operations.

(30) The signal-controlling apparatus, described in item 27, characterized in that

the signal-processing means are signal-processing devices, and

the controlling of the data transmitting/receiving operations and synchronizing operations in the clock-signal generating sections are performed between the signal-processing devices, based on the load signals.

According to the above invention, the signal-processing means cited in item 27 are the signal-processing devices, so that the controlling of the data transmitting/receiving operations and synchronizing operations in the clock-signal generating sections are performed between the signal-processing devices, based on the load signals.

As a result, the continuous transmission of clock signals between signal-processing circuits are eliminated, and therefore, the problem of electro-magnetic radiation is solved, and further, the problem of the frequency deviation of clock signals is also solved by employing the load signals for the synchronizing operations.

(31) The signal-controlling apparatus, described in anyone of items 27-30, characterized in that,

the clock-generating section, provided in the signal-processing means, includes a delay chain section that generates a plurality of delayed-clock pulses by delaying a reference oscillation signal from a reference oscillator in slightly different delay times, a synchronized-signal detecting section that detects a delayed signal synchronized with the load signal, and a delayed signal selecting section that selects the delayed signal synchronized with the load signal from the delay chain section corresponding to the detected result of the synchronized-signal detecting section and outputs it.

According to the above invention, initially, the delay chain section generates a plurality of delayed-clock pulses by delaying a reference oscillation signal from a reference oscillator in slightly different delay times, and the synchronized-signal detecting section detects a delayed signal synchronized with the load signal. Then, the delayed signal selecting section selects the delayed signal synchronized with the load signal from the delay chain section corresponding to the detected result of the synchronized-signal detecting section and outputs it. As a result, since the clock-generating section, provided in the signal-processing means, generates clock signals to which the synchronizing operation is applied on the basis of the load signals, it becomes possible to eliminate the clock signal transmitting operations between the signal-processing means.

(32) The signal-controlling apparatus, described in anyone of items 27-31, characterized in that each of sections included in the signal-controlling apparatus is composed of digital circuits.

According to the above invention, since each of sections included in the signal-controlling apparatus is composed of digital circuits, it becomes possible to easily and accurately perform the synchronizing operation in each of the signal-processing means in a digital way. Further, by employing the digital circuits, it becomes possible to integrate the whole configuration of the circuits into one tip IC, resulting in shortening of the wirings, easiness of the controlling operation, and further, improvement of the accuracy.

(33) The signal-controlling apparatus, described in item 31, characterized by further comprising,

a selector controlling section (hereinafter, also referred to as a synchronized switching section) to perform an arithmetic processing for fine adjustments when selecting the delayed signal synchronized with the load signal from the delay chain section corresponding to the detected result of the synchronized-signal detecting section.

According to the above invention, since the selector controlling section performs the arithmetic processing for fine adjustments when selecting the delayed signal synchronized with the load signal from the delay chain section corresponding to the detected result of the synchronized-signal detecting section, it becomes possible to accurately conduct the synchronizing operation in each of the signal-processing means.

(34) The signal-controlling apparatus, described in anyone of items 27-32, characterized by further comprising:

storing means for storing setting data with respect to the synchronizing operation; and

controlling means for controlling each of sections included in the signal-controlling apparatus by referring to the setting data stored in the storing means.

According to the above invention, the storing means stores the setting data with respect to the synchronizing operation, and the controlling means controls each of the sections included in the signal-controlling apparatus by referring to the setting data stored in the storing means. Accordingly, it becomes possible to easily and accurately perform the synchronizing operation of the clock signals in each of the signal-processing means.

(35) The signal-controlling apparatus, described in anyone of items 27-32, characterized by further comprising:

communication means for receiving setting data with respect to the synchronizing operation from outside; and

controlling means for controlling each of sections included in the signal-controlling apparatus by referring to the setting data inputted through the communication means.

According to the above invention, the communication means receives the setting data with respect to the synchronizing operation from outside, and the controlling means controls each of the sections included in the signal-controlling apparatus by referring to the setting data received. Accordingly, it becomes possible to easily and accurately perform the synchronizing operation of the clock signals in each of the signal-processing means.

(36) The signal-controlling apparatus, described in anyone of items 27-32, characterized by further comprising:

terminal means, from which setting data with respect to the synchronizing operation are inputted; and

controlling means for controlling each of sections included in the signal-controlling apparatus by referring to the setting data inputted through the terminal means.

According to the above invention, the controlling means controls each of the sections included in the signal-controlling apparatus by referring to the setting data inputted from outside trough the terminal means. Accordingly, it becomes possible to easily and accurately perform the synchronizing operation of the clock signals in each of the signal-processing means by also employing the setting data inputted.

(37) A image-forming apparatus, characterized in that,

in the image-forming apparatus, which comprises a plurality of signal-processing means, each having a clock-signal generating section and controlled by the data signals, clock signals and load signals, and which are coupled to each other through a synchronized serial interface for bilaterally communicating the data signals in a state synchronized with clock signals,

the plurality of signal-processing means are coupled to each other with a data communication line through which the data signals are bilaterally communicated between the plurality of signal-processing means and a load-signal communication line through which load signals are transmitted, and

anyone of the plurality of signal-processing means transmits the load signals to other signal-processing means, while the others control data transmitting/receiving operations and perform synchronizing operations in the clock-signal generating sections, based on the load signals.

According to the above invention, when the plurality of signal-processing means are controlled by the data signals, clock signals and load signals, and are coupled to each other through the synchronized serial interface for bilaterally communicating the data signals in the state synchronized with the clock signals, the plurality of signal-processing means are coupled to each other with the data communication line through which the data signals are bilaterally communicated between the plurality of signal-processing means and the load signals communication line through which the load signals are transmitted, and anyone of the plurality of signal-processing means transmits the load signals to other signal-processing means, while the others control data transmitting/receiving operations and perform synchronizing operations in the clock-signal generating sections, based on the load signals.

As a result, clock-signal transmitting lines and the transmission of clock signals between signal-processing means provided in the image-forming apparatus are eliminated, and therefore, the problem of electromagnetic radiation is solved, and further, the problem of the frequency deviation of clock signals is also solved by employing the load signals for the synchronizing operations.

Further, the abovementioned invention can be applied to such a case that the image-forming operations are performed between a plurality of image-forming apparatus in a state of synchronizing with each other. In this case, it becomes possible to simplify the signal transmitting paths even between the plurality of image-forming apparatus and to conduct the synchronized operations with the serial data transmission in a state of solving the electromagnetic radiation problem caused by the clock signals.

### BRIEF DESCRIPTION OF THE DRAWINGS

Other objects and advantages of the present invention will become apparent upon reading the following detailed description and upon reference to the drawings in which:

FIG. 1 shows a schematic diagram of an electronic configuration of a signal-controlling apparatus main section, embodied in the present invention as a first example;

FIG. 2 shows a schematic diagram of an electronic configuration of a whole system, including signal-controlling apparatus, embodied in the present invention as a first example;

FIG. 3 shows a circuit configuration of delay cells cascaded as a chain and employed in a signal-controlling apparatus embodied in the present invention;

FIG. 4 shows a time chart of delayed clock signals, which are generated in the circuit configuration shown in FIG. 3;

FIG. 5 shows another time chart of delayed clock signals, which are generated in the circuit configuration shown in FIG. 3;

FIG. 6 shows a flowchart for explaining operations of signal-controlling apparatus, embodied in the present invention as a first example;

FIG. 7 shows a time chart for explaining an operating status of the signal-controlling apparatus, embodied in the present invention as a first example;

FIG. 8 shows another time chart for explaining an operating status of the signal-controlling apparatus, embodied in the present invention as a first example;

FIG. 9 shows a schematic diagram of an electronic configuration of a signal-controlling apparatus main section, embodied in the present invention as a second example;

FIG. 10 shows a schematic diagram of an electronic configuration of a whole system, including signal-controlling apparatus, embodied in the present invention as a second example;

FIG. 11 shows a time chart, which indicates time differences between a reference pulse having a skew and delayed clock signals generated in the circuit configuration shown in FIG. 3; and

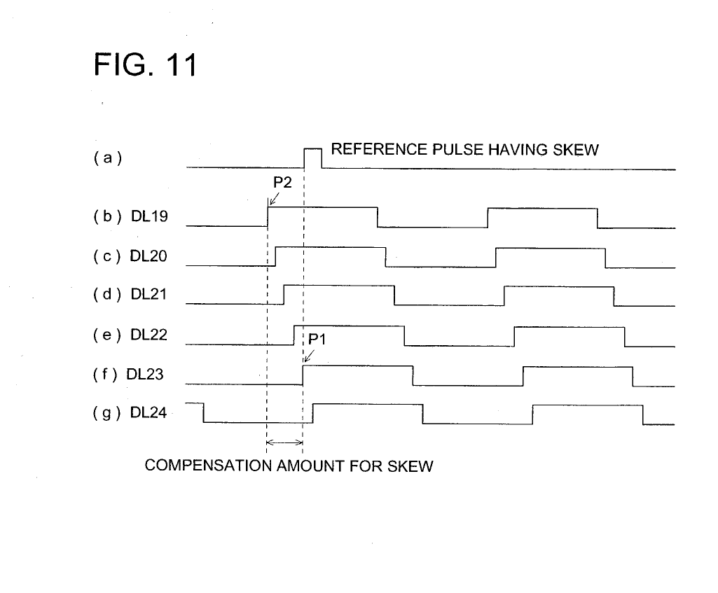

FIG. 12 shows another time chart for explaining an operating status of the signal-controlling apparatus, embodied in the present invention as a second example.

### DETAILED DESCRIPTION OF THE PREFERRED EMBODIMENT

Referring to the drawings, a first example of the signal-controlling apparatus embodied in the present invention will be detailed in the following. Initially, the whole configuration of the signal-controlling apparatus will be detailed.

<Summarized Explanation of the Signal-Controlling Apparatus>

The signal-controlling apparatus or image-forming apparatus, embodied in the present invention as a first embodiment, are coupled to each other through a synchronized serial interface for bilaterally communicating data signals in a state synchronized with clock signals, and include signal-processing circuits controlled by the data signals, clock signals and reference pulses, and further, have the features described in following items 1-7.

(1) The signal-processing circuits are controlled by the data signals, clock signals and reference pulses. When the signal-controlling apparatus are coupled to each other through a synchronized serial interface for bilaterally communicating the data signals in a state synchronized with clock signals, a plurality of signal-processing circuits are coupled to each other with a data communication line through which the data signals are bilaterally communicated between the plurality of signal-processing circuits and a reference pulse communication line through which reference pulses are transmitted, and anyone of the plurality of signal-processing circuits acts as a master circuit, while others act as slave circuits. At first, in a measuring time prior to an operating time, the master signal-processing circuit transmits the reference pulse to the slave signal-processing circuit at intervals of a predetermined time period, while, in the measuring time, the slave signal-processing circuit receives the reference pulse to measure a frequency deviation of clock signals, generated in said clock-generating section, by measuring the interval between the reference pulses with the clock signals generated by the oscillator. Then, in the operating time after the measuring time, the slave signal-processing circuit adjusts the frequency deviation of clock signals, based on the measuring result made in the measuring time. Through the abovementioned process, the clock signals of the slave signal-processing circuits are synchronized with that of the master signal-processing circuit. As a result, clock-signal transmitting lines and the transmission of clock signals between signal-processing circuits are eliminated, and therefore, the problem of electromagnetic radiation is solved, and further, the problem of the frequency deviation of clock signals is also solved by employing the reference pulse. In other words, since the operation for adjusting the frequency deviation of clock signals are performed in the measuring time without really transmitting the clock signals, it becomes possible to perform the serial data transmitting operation in the operating time without causing the problems of electromagnetic radiation and the frequency deviation of clock signals.

(2) The clock-generating section, provided in the slave signal-processing circuit, generates a plurality of delayed-clock pulses by delaying a reference oscillation signal in slightly different delay times, and detects a number of delay stages, being a number of delayed signal synchronized with the reference oscillation signal, and a number of synchronized delay-stages, being a number of stages between plural delayed signals synchronized with the reference oscillation signal. Further, in the clock-generating section, the time interval between the reference pulses is measured by counting the clock signals in a unit of one clock pulse and measuring the time interval smaller than one clock pulse by referring the number of delay stages and the number of synchronized delay-stages, in order to measure the frequency deviation of clock signals generated in the clock-generating section in an accuracy of smaller than one clock pulse during the measuring time. Accordingly, by performing the measurement of the frequency deviation of the clock signals in an accuracy of smaller than one clock pulse by employing the digital delay adjusting method in the measuring time without causing the problems of electromagnetic radiation in the signal-processing circuits controlled by the data signals, the clock signals and the reference pulses, it becomes possible to perform the serial data transmitting operation without causing the problem of the frequency deviation even in the operating time.

(3) By comparing the result of measuring the time interval between the reference pulses in an accuracy of smaller than one clock pulse during the measuring time with the predetermined time period between the reference pulses, the adjusting coefficient for adjusting the frequency deviation of the clock signals is found, so as to control the selection of the delayed signals in the operating time. Concretely speaking, by performing the measurement of the frequency deviation of the clock signals in an accuracy of smaller than one clock pulse in the measuring time and performing the deviation adjustment for every clock signal in an accuracy of smaller than one clock pulse in the operating time by employing the digital delay adjusting method without causing the problems of electromagnetic radiation in the signal-processing circuits controlled by the data signals, the clock signals and the reference pulses, it becomes possible to perform the serial data transmitting operation without causing the problem of the frequency deviation of the clock signals.

(4) By composing each of signal-processing circuits from digital circuits, it is possible to structure a plurality of signal-processing circuits within a low cost. Further, by employing the digital circuits, it becomes possible to integrate the whole configuration of the circuits into one tip IC, resulting in shortening of the wirings, easiness of the controlling operation, and further, improvement of the accuracy.

(5) By composing each section from digital circuits and controlling them with CPU, it is possible to structure a plurality of signal-processing circuits within a low cost. Further, by employing the digital circuits, it becomes possible to integrate the whole configuration of the sections into one tip IC, resulting in shortening of the wirings, easiness of the controlling operation, and further, improvement of the accuracy.

(6) In an image-forming apparatus, the signal-processing circuits are controlled by the data signals, clock signals and reference pulses. When the image-forming apparatus are coupled to each other through a synchronized serial interface for bilaterally communicating the data signals in a state synchronized with clock signals, a plurality of signal-processing circuits are coupled to each other with a data communication line through which the data signals are bilaterally communicated between the plurality of signal-processing circuits, and anyone of the plurality of signal-processing circuits acts as a master circuit, while others act as slave circuits. At first, in a measuring time prior to an operating time, the master signal-processing circuit transmits the reference pulse to the slave signal-processing circuit at intervals of a predetermined time period, while, in the measuring time, the slave signal-processing circuit receives the reference pulse to measure a frequency deviation of clock signals, generated in said clock-generating section, by measuring the interval between the reference pulses with the clock signals generated by oscillator 1122). Then, in the operating time after the measuring time, the slave signal-processing circuit adjusts the frequency deviation of clock signals, based on the measuring result made in the measuring time. Through the abovementioned process, the clock signals of the slave signal-processing circuits are synchronized with that of the master signal-processing circuit. As a result, clock-signal transmitting lines and the transmission of clock signals between signal-processing circuits are eliminated, and therefore, the problem of electro-magnetic radiation is solved, and further, the problem of the frequency deviation of clock signals is also solved by employing the reference pulse. In other words, according to the image-forming apparatus, embodied in the present invention, since the operation for adjusting the frequency deviation of clock signals are performed in the measuring time without really transmitting the clock signals, it becomes possible to perform the serial data transmitting operation in the operating time without causing the problems of electromagnetic radiation and the frequency deviation of clock signals.

[Whole Configuration of Signal-Controlling Apparatus]

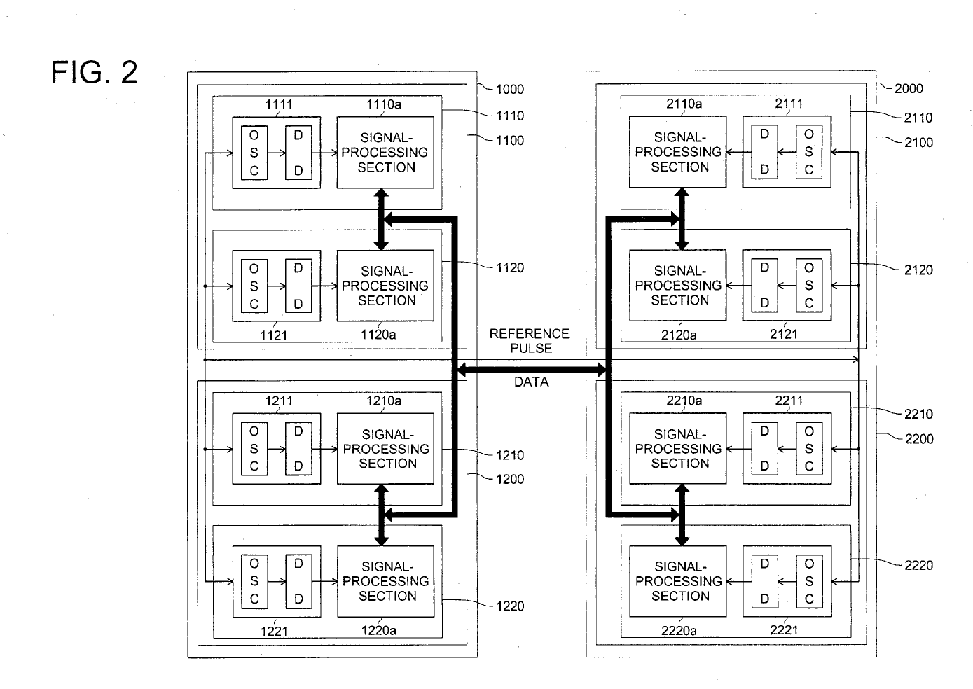

Referring to FIG. 2, a system configuration, in which a plurality of signal-controlling apparatus are coupled to each other in tandem (a tandem operating mode), will be detailed in the following. In the system configuration, each of the plurality of signal-controlling apparatus comprises a plurality of signal-processing circuits driven by clock signals having the same frequency and phase in the apparatus.

In the above configuration, first signal-controlling apparatus 1000 and second signal-controlling apparatus 2000 are coupled to each other through data communication lines for communicating the data between them and reference pulse lines for bilaterally transmitting the reference pulses, so as to operate the system with the clock signals having the same frequency and phase. Incidentally, since the reference pulse is utilized for both an inherent purpose of it (such as a trigger signal for triggering the data communicating operation) and another purpose for adjusting the frequency deviation of clock signals, as detailed later, it becomes possible to omit clock signal lines which have been indispensable in the conventional configuration, and thereby, to simplify the signal paths.

Further, in the above configuration, a plurality of signal-processing circuits (signal-processing circuit 1110 and signal-processing circuit 1120) are arranged on a single circuit board (circuit board 1100) equipped in a single apparatus (signal-controlling apparatus 1000). In the same manner, a plurality of signal-processing circuits (signal-processing circuit 1210 and signal-processing circuit 1220) are arranged on a single circuit board (circuit board 1200) equipped in the single apparatus (signal-controlling apparatus 1000). Further, a plurality of signal-processing circuits (signal-processing circuit 2110 and signal-processing circuit 2120) are arranged on a single circuit board (circuit board 2100) equipped in a single apparatus (signal-controlling apparatus 2000). In the same manner, a plurality of signal-processing circuits (signal-processing circuit 2210 and signal-processing circuit 2220) are arranged on a single circuit board (circuit board 2200) equipped in the single apparatus (signal-controlling apparatus 2000).

Still further, a plurality of signal-processing circuits (signal-processing circuit 1110 and signal-processing circuit 1120, signal-processing circuit 1210 and signal-processing circuit 1220) are arranged on separate circuit boards (circuit board 1100 and circuit board 1200) equipped in the single apparatus (signal-controlling apparatus 1000). In the same manner, a plurality of signal-processing circuits (signal-processing circuit 2110 and signal-processing circuit 2120, signal-processing circuit 2210 and signal-processing circuit 2220) are arranged on separate circuit boards (circuit board 2100 and circuit board 2200) equipped in the single apparatus (signal-controlling apparatus 2000).

Incidentally, each of signal-processing circuits (1110, 1120, 1210, 1220, 2110, 2120, 2210, 2220) comprises each of clock-generating sections (1111, 1121, 1211, 1221, 2111, 2121, 2211, 2221), which includes oscillator OSC and digital delay clock adjusting means DD.

Incidentally, in the configuration mentioned above, the “signal-processing circuit” could be a signal-processing device structured by digital circuits, etc. Further, in the same manner, in the configuration mentioned above, the “apparatus” could be an image-forming apparatus, namely an image-forming apparatus comprising a plurality of signal-processing circuits.

Incidentally, the clock-generating section employed in this embodiment generates delay signals, which are delayed in slightly different delay times so as to select a clock signal synchronized in each of signal-processing circuits, as detailed later. Concretely speaking, in the embodiment of the present invention, a plurality of delayed signals are generated by delaying clock-pulses, outputted from oscillator OSC, in slightly different delay times, and then, a suitable delayed signal is selected out of the plurality of delayed signals so that the selected delayed signal is employed for driving each of signal-processing circuits. For this purpose, although the digital delay clock adjusting means described later is employed in the present embodiment, an analogue delay means (such as a delay line) can be also employed as another means other than the above.

Further, each of signal-processing circuits (1110, 1120, 1210, 1220, 2110, 2120, 2210, 2220) comprises each of signal-processing sections (1110a, 1120a, 1210a, 1220a, 2110a, 2120a, 2210a, 2220a), which perform signal processing operations.

[Detailed Configuration of Signal-Controlling Apparatus]

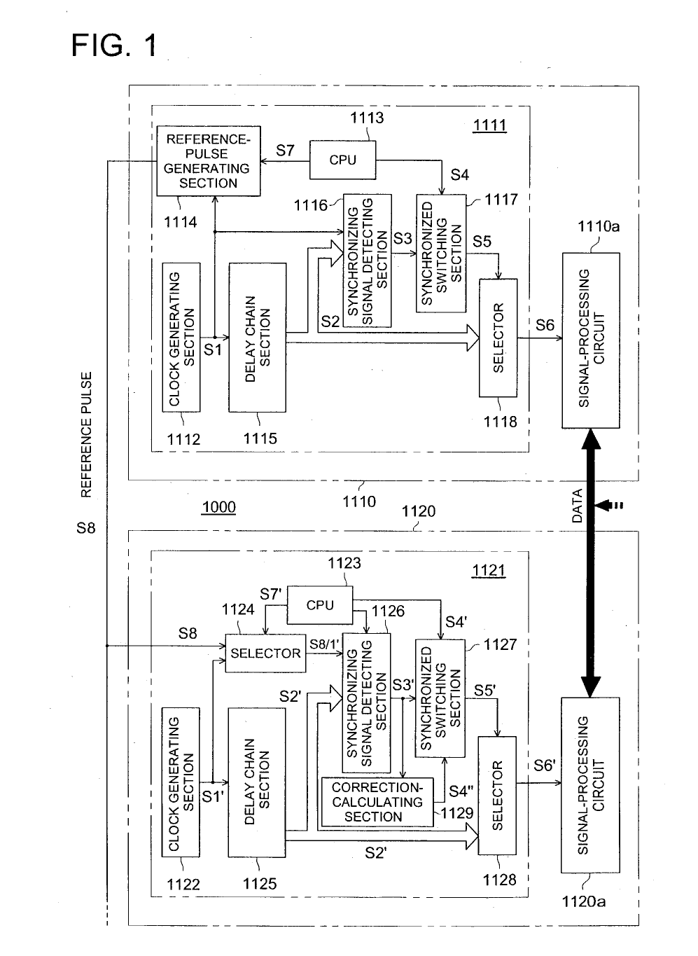

Referring to FIG. 1, a detailed configuration of the main section of the signal-controlling apparatus, comprising a plurality of signal-processing circuits driven by the clock signals having the same frequency and phase, will be detailed in the following by exemplifying a plurality of signal-processing circuits (signal-processing circuit 1110 and signal-processing circuit 1120) arranged on the single circuit board (circuit board 1100) of the single apparatus (signal-processing apparatus 1000) as a concrete example.

Incidentally, the operations detailed in the following can be also applied in the same manner to a plurality of signal-processing circuits mounted on the other signal-processing circuit, a plurality of signal-processing circuits arranged on the different circuit boards, and the signal-processing circuits distributed among plural apparatus being different each other.

Further, a concrete example in which signal-processing circuit 1110 is a master signal-processing circuit while signal-processing circuit 1120 is a slave signal-processing circuit will be detailed in the following.

In signal-processing circuit 1110, clock-generating section 1111 and signal-processing circuit 1110a, driven by the clock signals generated by clock-generating section 1111, are arranged. Further, clock-generating section 1111 comprises oscillator (OSC) 1112 oscillating at a predetermined frequency, CPU 1113 serving as a controlling means, reference-pulse generating section 1114 for transmitting reference pulses at a predetermined interval, delay chain section 1115 for generating a plurality of delayed signals having different delay times by delaying oscillation signals, outputted from oscillator 1112, in slightly different delay times, synchronizing signal detecting section 1116 for detecting a synchronizing signal from a large number of delayed signals, synchronized switching section 1117 for performing a synchronized switching operation and selector 1118, serving as a selecting means, for selecting a certain delayed signal out of a large number of delayed signals.

Incidentally, in the measuring period before entering the real-operating period, reference-pulse generating section 1114 transmits the reference pulses at the predetermined interval to signal-processing circuit 1120 serving as a slave signal-processing circuit, based on the command signal received from CPU 1113 and the clock signals received from oscillator 1112. Hereinafter, the “reference pulses” at the predetermined interval comprises at least two pulses, occurring interval of which is determined in advance (for instance, duration of 100 clock pulses).

Further, in signal-processing circuit 1120, clock-generating section 1121 and signal-processing circuit 1120a, driven by the clock signals generated by clock-generating section 1121, are arranged. Further, clock-generating section 1121 comprises oscillator (OSC) 1122 oscillating at a predetermined frequency, CPU 1123 serving as a controlling means, selector 1124 for performing a switching operation between the measuring period and the real-operating period, delay chain section 1125 for generating a plurality of delayed signals having different delay times by delaying oscillation signals, outputted from oscillator 1122, in slightly different delay times, synchronizing signal detecting section 1126 for detecting a synchronizing signal from a large number of delayed signals, synchronized switching section 1127 for performing a synchronized switching operation, selector 1128, serving as a selecting means, for selecting a certain delayed signal out of a large number of delayed signals and correction-calculating section 1129 for performing a correction calculating (such as a measurement of the clock signals with the reference pulses and a calculation of an adjusting coefficient for correcting the clock signals).

Incidentally, when the direction of transmitting the data is reversed between a transmission and a reception in the serial data communicating operation, the direction of transmitting the reference pulses is also reversed as well. In order to accord with this operation, the operation for adjusting the frequency deviation of the clock signals is also performed in the reversed direction.

It is desirable that reference-pulse generating section 1114 equipped in the master signal-processing circuit, selector 1124 and correction-calculating section 1129 equipped in the slave signal-processing circuit are provided with both master and slave signal-processing circuits so as to selectively use a necessary function in response to a role as a master or a slave signal-processing circuit.

[Explanation of Basic Configuration of Signal-Controlling Circuit]

A generation of delay signals, a detection of synchronizing signals and a selection (a fundamental digital-delay processing), which are basic processing performed in the signal-processing circuit, will be detailed in the following.

(A) Generation of Delayed Signals

In delay chain sections 1115, 1125, it is desirable that the delay elements, such as inverters, are cascaded as a chain in such a number of stages that the delayed clock signals, phases of which are slightly different relative to each other, can be formed over at least one period, or more desirably two periods, of the reference oscillation signal.

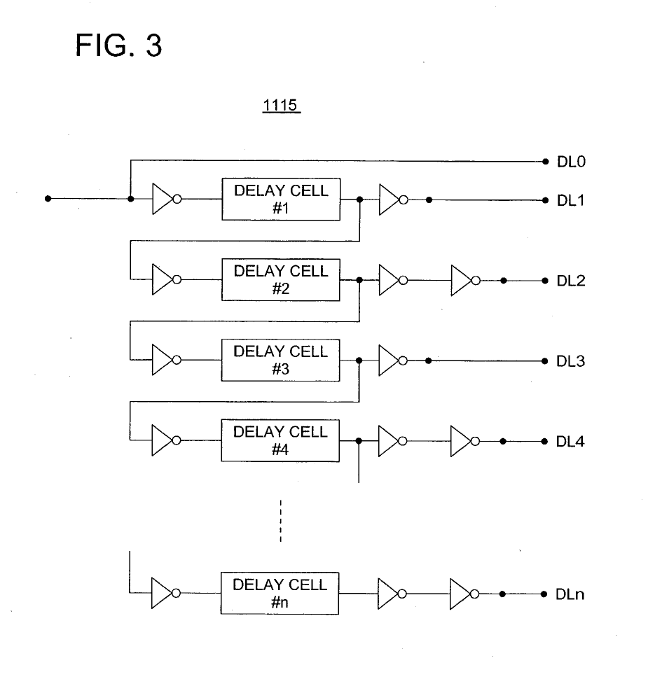

For instance, as shown in FIG. 3, delay cells, each of which serves as a delay element having a microscopic delay time sufficiently smaller than one period of the reference oscillation signal generated by the oscillator, are cascaded as a chain so that each of the delay cells outputs the delayed clock signal, phase of which is slightly different from those of former and latter delayed clock signals.

FIG. 3 shows a circuit diagram of delay chain section 1115, which receives the reference oscillation signal from oscillator 1112. In FIG. 3, DL0 indicates a delayed clock signal, which does not go through any delay cell, DL1 indicates a delayed clock signal, which goes through one stage of the delay cells, DL2 indicates a delayed clock signal, which goes through two stages of the delay cells and DLn indicates a delayed clock signal, which goes through “n” stages of the delay cells. Incidentally, each configuration of the other delay chain sections is the same as that of the above. Further, in regard to the delay chain section, it is desirable that a circuit configuration or layout in which distortion of duty cycles in delayed clock signals are minimized and output intervals between the stages are divided as finely and uniformly as possible, by duplicating elements, such as inverters having a microscopic delay time and inverting logic, next to the delay element.

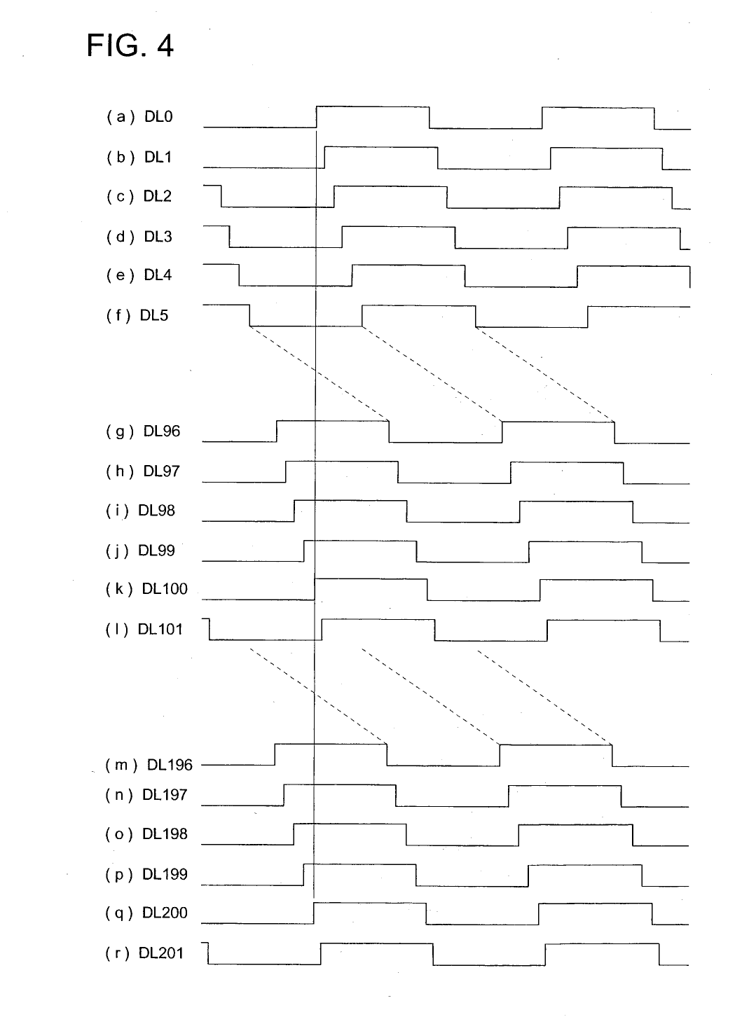

FIG. 4 shows a time chart of delayed clock signals, which are generated in the circuit configuration shown in FIG. 3. DL0 is indicated on line (a), which does not go through any delay cell and whose status is the same as that of the reference oscillation signal sent from oscillator 1112. In the following lines, the numeral attached next to the notation of “DL” indicates the number of delay stages, namely, the delayed clock signal, which goes through one stage of the delay cells, is denoted by DL1, the delayed clock signal, which goes through two stages of the delay cells, is denoted by DL2, the delayed clock signal, which goes through 100 stages of the delay cells, is denoted by DL100 and the delayed clock signal, which goes through 200 stages of the delay cells, is denoted by DL200. In FIG. 3, the phase of DL0 coincides with the phase of DL100 and DL200.

(B) Detection of Synchronizing Signals

Synchronizing-signal detecting sections 1116, 1126 serve as detecting means for selecting a specific delayed signal, synchronizing with the timing signal (in this embodiment, clock signals CLK outputted from a clock generating section, or signals generated by synchronizing with clock signals CLK, or DL0 having no delay), out of a group of delayed signals (S2, S2′ in FIG. 1), and for detecting a number of stages (synchronized point) of the selected delayed signal to output a synchronized point information (S3, S3′ in FIG. 1). Incidentally, it is desirable that synchronizing signal-detecting sections 1116, 1126 can output both first synchronized point information SP1, synchronized with the timing signal at first, and second synchronized point information SP2, synchronized with the timing signal at second, detecting from the group of delayed signals (S2, S2′ in FIG. 1).

Since there is a possibility that delay times of the plurality of delayed signals outputted from delay chain sections 1115, 1125 can be varied under the influences of the temperature change, etc., the number of delayed signals included within a predetermined and stable time-interval (an interval between a timing signal and its next timing signal (since the crystal oscillator is employed in the clock generating section, little change could occur)) is detected in advance as aforementioned.

By conducting the aforementioned process, even if the delay time of the individual delay cell varies with the temperature change, the overall system of the apparatus cannot be suffered by any influence of them, resulting in an advantageous point of the present invention.

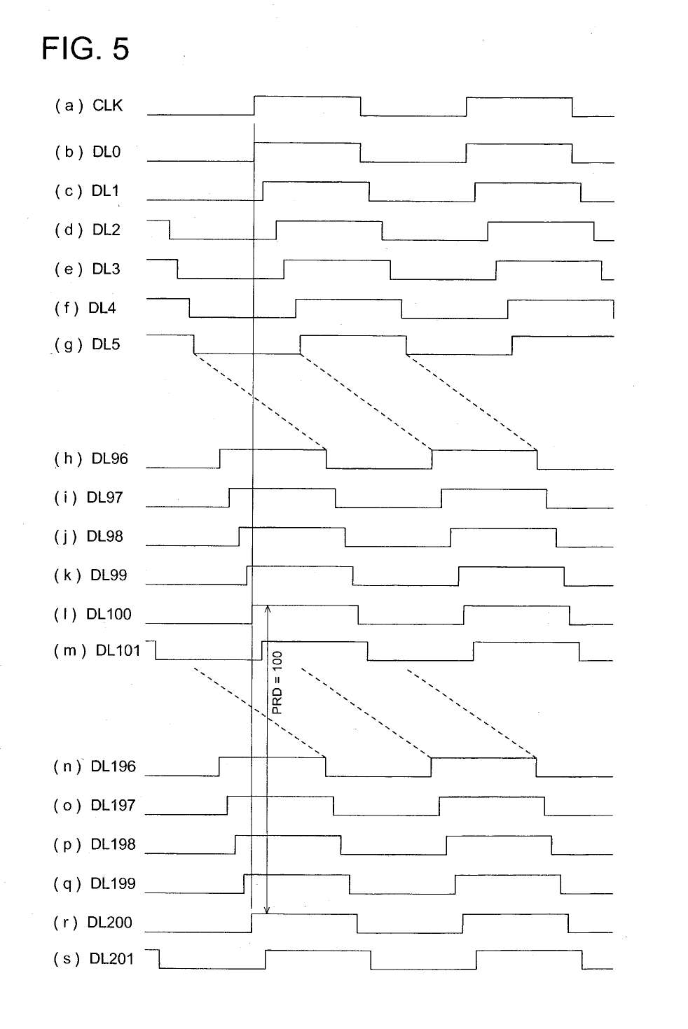

In the example shown in FIG. 5, the phases of DL100 and DL200 coincide with that of the timing signal (shown in line (a) of FIG. 5) and DL0 without any delay (shown in line (b) of FIG. 5). Accordingly, it is determined as SP1=100, SP2=200. Namely, the number of stages for one period (number of synchronized delay stages) PRD is determined as PRD=SP1−SP2=200−100=100.

(C) Selection Controlling Operation

Each of synchronized switching sections 1117, 1127 outputs a select signal (S5, S5′ in FIG. 1) for designating a specific delayed signal to be selected out of the group of the delayed signals (S2, S2′ in FIG. 1), corresponding to the synchronized point information (S3, S3′ in FIG. 1) outputted from synchronizing signal-detecting sections 1116, 1126 and a necessary adjusting coefficient (S4″ in FIG. 1).

In this operation, although there is a possibility that a delay time per one delay stage of delay chain sections 1115, 1125 can be varied under the influences of the temperature change, etc., it is possible to find the delay time per one delay stage by calculating the number of synchronized delay stages PRD included in period T of one clock signal in an accuracy of crystal oscillator.

For this purpose, each of synchronized switching sections 1117, 1127 receives the delay time per one delay stage T/PRD found in the abovementioned process and an adjusting amount (S4, S4′ in FIG. 1) sent from CPU, and generates a select signal (S5, S5′ in FIG. 1) for designating a specific delayed signal to be selected out of the group of the delayed signals (S2, S2′ in FIG. 1) to output it to selector 1118, 1128.

(D) Pulse Selection, Clock Output:

Each of selectors 1118, 1128 receives a number of select stages included in the select signal (S5, S5′ in FIG. 1) sent from each of synchronized switching sections 1117, 1127 and selects a specific delay signal having a corresponding phase out of the group of the delayed signals (S2, S2′ in FIG. 1) to output it as a clock signal (S6, S6′ in FIG. 1).

As a result, even if the delay time of one delay stage of delay chain sections 1115, 1125 varies under the influences of the temperature change, etc., each of selectors 1118, 1128 can output clock signals having a constant frequency.

Incidentally, in addition to the fact that stable clock signals can be outputted by the operations of the generation of delayed signals, the synchronized-signal detection and the pulse selection, these serving as a fundamental digital delay processing mentioned above, the present embodiment is characterized in that the frequency of the clock signals in slave side can coincide with that in master side by performing the following operations (measuring period/real-operating period).

In other words, signal-processing circuit 1110, serving as a master circuit, generates stable clock signals through the fundamental digital delay processing mentioned above. Further, in addition to the generation of the stable clock signals, signal-processing circuit 1120, serving as a slave circuit, performs a processing for coinciding with the frequency of the clock signals in the master side.

<Detailed Explanation of Signal-Processing Apparatus>

An example of the signal-processing apparatus, embodied in the present invention, will be detailed in the following. Incidentally, the whole operation of the signal-processing apparatus, embodied in the present invention, can be roughly divided into a first operation in a measuring period and a second operation in a real-operating period.

Further, signal-processing circuits includes a master signal-processing circuit and a slave signal-processing circuit. Still further, each of CPUs may conduct controlling operations in both the measuring period and the real-operating period. In the following, operations of the signal-processing apparatus will be detailed in due succession.

[1] Measuring Period:

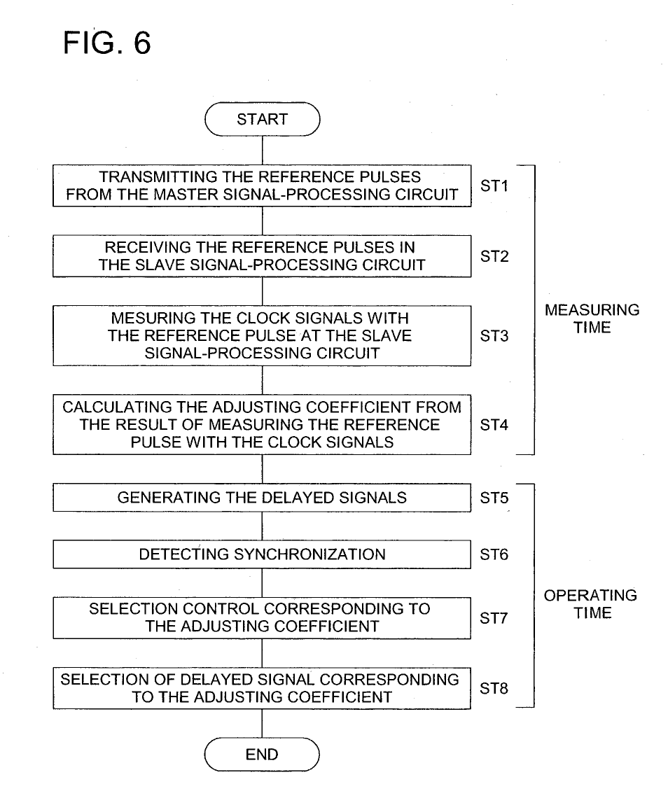

In the measuring period before the real-operating period, master signal-processing circuit 1110 receives a command signal (S7 in FIG. 1) sent from CPU 1113, and transmits reference pulses (S8 in FIG. 1) with a predetermined interval to slave signal-processing circuit 1120 (ST1 in FIG. 6). Incidentally, the “reference pulses with a predetermined interval” is defined as a signal having at least two pulses occurring at an interval determined in advance. In this embodiment, the “reference pulses with a predetermined interval” are two pulses occurring at the interval equivalent to duration of 100 clock signals.

On the other hand, in the measuring period before the real-operating period, slave signal-processing circuit 1120 receives a command signal (S7′ in FIG. 1) sent from CPU 1113, and switches selector 1124 so that the reference pulses (S8 in FIG. 1) pass through it. Accordingly, synchronized-signal detecting section 1126 detects a number of stages (synchronized point) of the delayed signal synchronized with the received reference pulses (S8 in FIG. 1), in the group of delayed signals (S2′ in FIG. 1) sent from delay chain section 1125 (ST6 in FIG. 6).

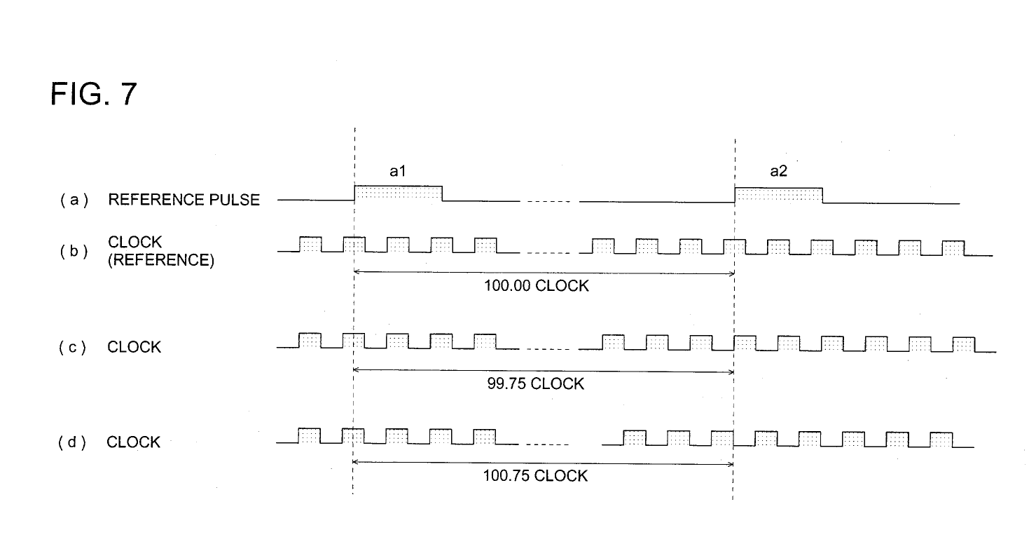

In other words, correction-calculating section 1129 receives the reference pulses (a1, a2 in line (a) of FIG. 7) with a predetermined interval (for instance, equivalent to duration of 100 clock signals generated by oscillator 1112, as shown in line (b) of FIG. 7).

Then, correction-calculating section 1129 in clock generating section 1121, receiving the reference pulses (a1, a2 in line (a) of FIG. 7) with the predetermined interval, measures the interval between the reference pulses. Concretely speaking, it is possible to measure the frequency deviation of clock signals generated by oscillator 1122 by measuring the interval between the reference pulses with the clock signals generated by oscillator 1122, since the interval should be equivalent to duration of 100 clock signals if the clock signals generated in clock generating section 1111 coincide with that generated in clock generating section 1121.

For instance, as shown in line (c) of FIG. 7, when the interval is equivalent to duration of 99.75 clock signals as a result of measuring with the number of synchronized stages PRD detected by synchronized-signal detecting section 1126, correction-calculating section 1129 finds an adjusting coefficient by calculating such an equation of

(99.75−100.00)/100.00=−0.0025.

The above result means that, to adjust a frequency of the clock signals generated in clock generating section 1121 at the same frequency as that in clock generating section 1111, it is necessary to advance the clock period by 0.0025 for every clock pulse. Further, for instance, as shown in line (d) of FIG. 7, when the interval is equivalent to duration of 100.25 clock signals as a result of measuring in correction-calculating section 1129, correction-calculating section 1129 finds an adjusting coefficient by calculating such an equation of

(100.25−100.00)/100.00=+0.0025.

The above result means that it is necessary to delay the clock period by 0.0025 for every clock pulse.

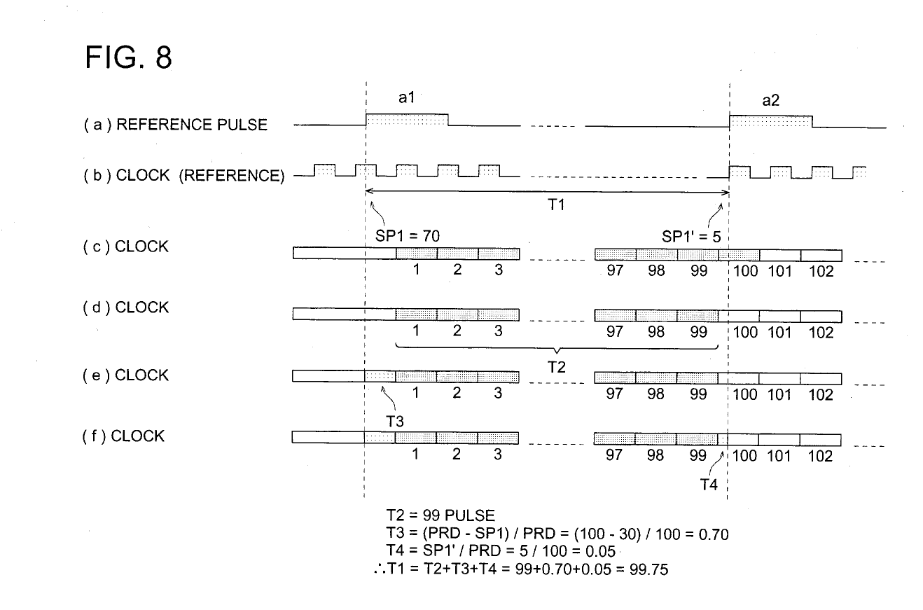

FIG. 8 shows a flowchart of measuring the reference pulses in correction-calculating section 1129. When the reference pulses shown in line (a) of FIG. 8 are received, a portion of time interval T1, in which the clock signals (shown in line (b) of FIG. 8) generated by oscillator 1122 are included in the interval between the reference pulses, is the measuring objective term.

The clock pulses, sent from oscillator 1122 in the measuring term T2 and including a starting-time, are 1-100 (refer to line (b) of FIG. 8). A counter, etc. provided in correction-calculating section 1129 measures the pulses completely included in measuring term T2. In this embodiment, 99 pluses are counted within measuring term T2 as shown in line (d) of FIG. 8.

Next, the duration term T3 (shown in line (e) of FIG. 8), being equal to or shorter than a period of one clock pulse, form the measurement start timing at the leading edge of the first reference pulse to the initial rising edge of the clock pulse, is found. The duration term T3 can be found, based on the number of synchronized stages PRD and first synchronized point information SP1 at the time of PRD, by calculating the equation of

(PRD−SP1)/PRD

Accordingly, when PRD=100 and SP1=30 at the time of PRD=100, the duration term T3 can be found as 0.70 by calculating the equation of (100−30)/100.

Next, the duration term T4 (shown in line (f) of FIG. 8), being equal to or shorter than a period of one clock pulse, form the final rising edge of the clock pulse to the measurement stop timing at the leading edge of the final reference pulse, is found. The duration term T4 can be found, based on the number of synchronized stages PRD and first synchronized point information SP1′ at the time of PRD, by calculating the equation of

SP1′/PRD.

Accordingly, when PRD=100 and SP1′=5 at the time of PRD=100, the duration term T4 can be found as 0.05 by calculating the equation of 5/100.

Accordingly, it is possible to find the measuring term T2 in accuracy of time shorter than a period of one clock pulse as T2=99+0.70+0.05=99.75. In other words, correction-calculating section 1129 not only measures the duration time between the reference pulses by counting the clock signals at a unit of one clock pulse, but also accurately measures the time shorter than a period of one clock pulse by referring to the detected result of synchronized-signal detecting section 1126.

As described in the above, by correction-calculating section 1129 measuring the reference pulses (S8 in FIG. 1) sent from master signal-processing circuit 1110 with the clock signals generated in slave signal-processing circuit 1120, it becomes possible to find the frequency deviation in the slave side and its adjusting coefficient (S4″ in FIG. 1).

[1]Real-Operating Period:

In the real-operating period after the measuring period, master signal-processing circuit 1110 stably outputs the clock signals by performing the fundamental digital delay processing, and therefore, conducts no other specific operations.

On the other hand, in the real-operating period after the measuring period, slave signal-processing circuit 1120 receives a command signal (S7′ in FIG. 1) sent from CPU 1113, so as to switch selector 1124 so that the clock signals (S1′ in FIG. 1) generated by oscillator 1122 pass through it. Accordingly, synchronized-signal detecting section 1126 detects a number of stages (synchronized point) of the delayed signal synchronized with the clock signals (S1′ in FIG. 1), in the group of delayed signals (S2′ in FIG. 1) sent from delay chain section 1125 (ST6 in FIG. 6).

Then, synchronized switching section 1127 receives the synchronized point information sent from synchronized-signal detecting section 1126 (S3′ in FIG. 1), the adjusting amount sent from CPU 1123 (S4′ in FIG. 1) and the adjusting coefficient sent from correction-calculating section 1129, in order to generate a select signal (S5′ in FIG. 1), which is utilized for selecting a delayed signal having a suitable phase out of a group of the delayed signals (S2′ in FIG. 1), and outputs the selected delayed signal to selector 1128 (ST7 in FIG. 6).

Further, selector 1128 receives a number of selecting stage included in the selecting signal (S5′ in FIG. 1), and selects the delayed signal having a corresponding phase out of a group of delayed signals (S2′ in FIG. 1), to output the delayed signal selected as the clock signals generated in clock-generating section 1121 (ST8 in FIG. 6).

As a result, even if the delay time of the individual delay cell varies with the temperature change, and further, is different from that in the master signal-processing circuit, selector 1128 can output the clock signals, the frequency and phase of which is constant and synchronized with those generated in the master side.

<Effect of Signal-Controlling Apparatus>

In the signal-controlling apparatus having the aforementioned configuration and features, the transmission of the clock signals and the signal lines for transmitting the clock signals between the signal-processing circuits are omitted, resulting in an elimination of electromagnetic radiation problems. Further, the frequency deviation problem of the clock signals can be also eliminated by employing the reference pulses. In other words, it becomes possible to communicate the serial data between signal-processing circuits, which is controlled by data signals, clock signals and reference signals, without causing the electromagnetic radiation problems and the frequency deviation problem of the clock signals.

Still further, for every case, such as signal-processing circuits arranged in plural apparatus being different relative to each other, signal-processing circuits arranged in a single apparatus, signal-processing circuits arranged on a single circuit board equipped in a single apparatus, etc., good results can be obtained. Concretely speaking, for a plurality of signal-processing circuits, which are arranged in a copier to perform image-processing operation operated with clock signals whose timings are the same, or for each of a plurality of copiers coupled to each other (a tandem operation) and signal-processing circuits equipped in each of them, good results can be obtained.

<Other Embodiments>

Although, as shown in FIG. 1, only the detailed configuration of signal-processing circuit 1110 coupled to signal-processing circuit 1120 is indicated in the first embodiment mentioned above, in the system in which a large number of the same signal-processing circuits are coupled to each other, it becomes possible to adjust the frequency of clock signals generated in the slave signal-processing circuits so as to coincide with that of the master signal-processing circuit, serving as a reference circuit.

Further, although the aforementioned signal-processing apparatus, embodied in the present invention, can be applied for various kinds of apparatus, it would result in very good features to employ it for an image-forming apparatus, such as a copier, a printer and a facsimile device, which has a circuit board for conducting a plurality of processing operations requiring synchronized processing.

Still further, in the system in which a plurality of image-forming apparatus are coupled to each other in a tandem mode and are operated in parallel in a synchronized state, it would result in very good features to employ the example of the first embodiment of the present invention.

Still further, although, in the first embodiment described in the foregoing, the digital delay clock adjusting means is employed, another type analogue delay means (such as an analogue delay line) can be also employed for this purpose. It is desirable, however, that the digital delay clock adjusting means is employed for this purpose rather than the analogue delay means, because of the structural advantage of 1 chip IC circuit, shortened wirings in the 1 chip IC circuit, minimized influence of errors caused by heat and temperature change, controlling easiness, etc.

In the aforementioned embodiments, the whole configuration of the plurality of signal-processing circuits and the CPUs can be structured by the digital circuits, when each of the signal-processing circuits is structured by the digital delay clock adjusting means. In this configuration, it becomes possible to easily and accurately conduct the operation for adjusting the frequency deviation in the clock-generating section of each signal-processing circuit in a digital operating mode.

Further, by structuring the whole circuit in a digital circuit, it becomes possible to reduce the manufacturing cost lower than fractions of that when employing a conventional analogue delay line. Still further, by structuring the whole circuit in a 1 chip IC circuit, such as a gate array, etc., the interferences between signals, which have conventionally occurred in the externally coupled analogue delay line, are not generated, resulting in a solution of the signal noise problem.

Next, referring to the drawings, a second example of the signal-controlling apparatus embodied in the present invention will be detailed in the following. Incidentally, the reference number same as that in the first embodiment will be attached to the block same as that in the first embodiment, and the explanation same as that in the first embodiment will be omitted in the following.

<Summarized Explanation of the Signal-Controlling Apparatus>

The signal-controlling apparatus or image-forming apparatus, embodied in the present invention as a second embodiment, are coupled to each other through a synchronized serial interface for bilaterally communicating data signals in a state synchronized with clock signals, and include signal-processing circuits controlled by the data signals, clock signals and load signals, and further, have the features described in following items 1-11.

(1) The plurality of signal-processing means are coupled to each other with a data communication line through which the data signals are bilaterally communicated between the plurality of signal-processing means and a load-signal communication line through which load signals are transmitted, and anyone of the plurality of signal-processing means transmits the load signals to other signal-processing means, while the others control data transmitting/receiving operations and perform synchronizing operations in the clock-signal generating sections, based on the load signals. As a result, clock-signal transmitting lines and the transmission of clock signals between signal-processing means are eliminated, and therefore, the problem of electromagnetic radiation is solved, and further, the problem of the frequency deviation of clock signals is also solved by employing the load signals for the synchronizing operations.

(2) The signal-processing means, described in item 1, are signal-processing circuits, so that the controlling of the data transmitting/receiving operations and synchronizing operations in the clock-signal generating sections are performed between the signal-processing circuits, based on the load signals. As a result, the continuous transmission of clock signals between signal-processing circuits are eliminated, and therefore, the problem of electro-magnetic radiation is solved, and further, the problem of the frequency deviation of clock signals is also solved by employing the load signals for the synchronizing operations.

(3) The signal-processing means, described in item 1, are signal-processing circuit boards, so that the controlling of the data transmitting/receiving operations and synchronizing operations in the clock-signal generating sections are performed between the signal-processing circuit boards, based on the load signals.

As a result, the continuous transmission of clock signals between signal-processing circuits are eliminated, and therefore, the problem of electromagnetic radiation is solved, and further, the problem of the frequency deviation of clock signals is also solved by employing the load signals for the synchronizing operations.

(4) The signal-processing means, described in item 1, are signal-processing devices, and the controlling of the data transmitting/receiving operations and synchronizing operations in the clock-signal generating sections are performed between the signal-processing devices, based on the load signals.

As a result, the continuous transmission of clock signals between signal-processing circuits are eliminated, and therefore, the problem of electromagnetic radiation is solved, and further, the problem of the frequency deviation of clock signals is also solved by employing the load signals for the synchronizing operations.

(5) The delay chain section generates a plurality of delayed-clock pulses by delaying a reference oscillation signal from a reference oscillator in slightly different delay times, and a synchronized-signal detecting section detects a delayed signal synchronized with the load signal. Then a delayed signal selecting section that selects the delayed signal synchronized with the load signal from the delay chain section corresponding to the detected result of the synchronized-signal detecting section and outputs it. As a result, since the clock-generating section, provided in the signal-processing means, generates clock signals to which the synchronizing operation is applied on the basis of the load signals, it becomes possible to eliminate the clock signal transmitting operations between the signal-processing means.

(6) Since each of sections included in the signal-controlling apparatus is composed of digital circuits, it becomes possible to easily and accurately perform the synchronizing operation in each of the signal-processing means in a digital way. Incidentally, by employing the digital-delay clock adjusting means, it becomes possible to structure a plurality of signal-processing circuits in a low cost, and to structure them as digital circuits. Further, by employing the digital circuits, it becomes possible to integrate the whole configuration of the circuits into one tip IC, resulting in shortening of the wirings, easiness of the controlling operation, and further, improvement of the accuracy.

(7) The selector controlling section performs an arithmetic processing for fine adjustments when selecting the delayed signal synchronized with the load signal from the delay chain section corresponding to the detected result of the synchronized-signal detecting section. Accordingly, it becomes possible to accurately conduct the synchronizing operation in each of the signal-processing means.

(8) The storing means stores the setting data with respect to the synchronizing operation, and the controlling means controls each of the sections included in the signal-controlling apparatus by referring to the setting data stored in the storing means. Accordingly, it becomes possible to easily and accurately perform the synchronizing operation of the clock signals in each of the signal-processing means.

(9) The communication means receives the setting data with respect to the synchronizing operation from outside, and the controlling means controls each of the sections included in the signal-controlling apparatus by referring to the setting data received. Accordingly, it becomes possible to easily and accurately perform the synchronizing operation of the clock signals in each of the signal-processing means.

(10) The controlling means controls each of the sections included in the signal-controlling apparatus by referring to the setting data inputted from outside trough the terminal means. Accordingly, it becomes possible to easily and accurately perform the synchronizing operation of the clock signals in each of the signal-processing means by also employing the setting data inputted.

(11) When the plurality of signal-processing means are controlled by the data signals, clock signals and load signals, and are coupled to each other through the synchronized serial interface for bilaterally communicating the data signals in the state synchronized with the clock signals, the plurality of signal-processing means are coupled to each other with the data communication line through which the data signals are bilaterally communicated between the plurality of signal-processing means and the load signals communication line through which the load signals are transmitted, and anyone of the plurality of signal-processing means transmits the load signals to other signal-processing means, while the others control data transmitting/receiving operations and perform synchronizing operations in the clock-signal generating sections, based on the load signals. As a result, since clock-signal transmitting lines and the transmission of clock signals between signal-processing means provided in the image-forming apparatus are eliminated, it becomes possible to simplify the signal transmitting paths even between the plurality of image-forming apparatus and to conduct the synchronized operations with the serial data transmission in a state of solving the electromagnetic radiation problem caused by the clock signals.

[Whole Configuration of Signal-Controlling Apparatus]

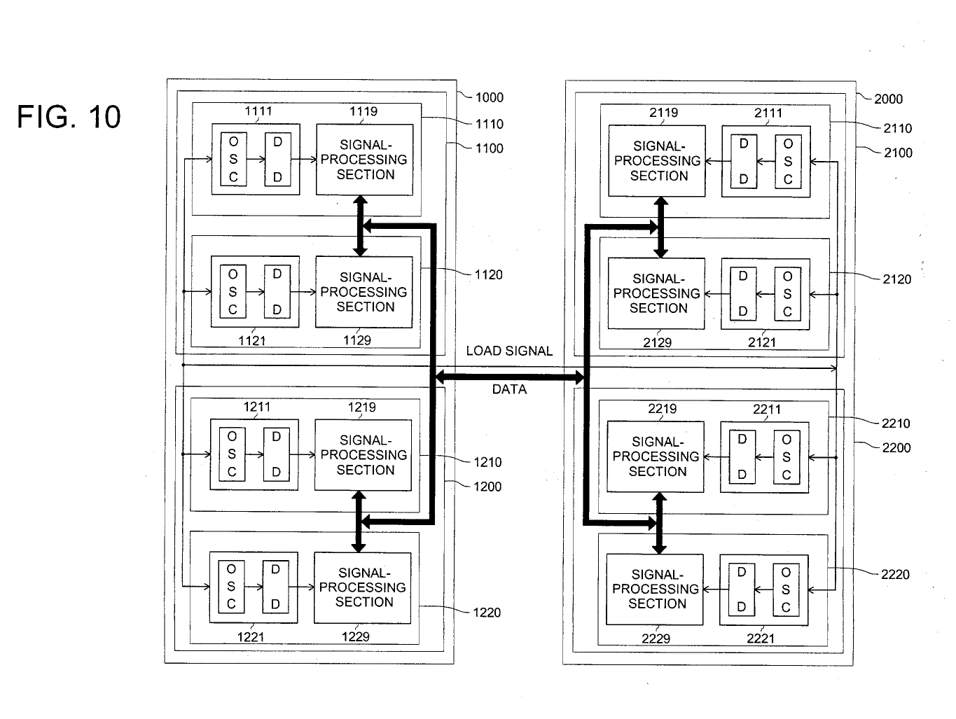

Referring to FIG. 10, a system configuration, in which a plurality of signal-controlling apparatus are coupled to each other in tandem (a tandem operating mode), will be detailed in the following. In the system configuration, each of the plurality of signal-controlling apparatus comprises a plurality of signal-processing circuits driven by clock signals having the same frequency and phase in the apparatus.

In the above configuration, first signal-controlling apparatus 1000 and second signal-controlling apparatus 2000 are coupled to each other through data communication lines for communicating the data between them and load-signal lines for bilaterally transmitting the load signal, so as to operate the system with the clock signals having the same frequency and phase. Incidentally, since the load signal is utilized for both an inherent purpose of it (such as a trigger signal for triggering the data communicating operation) and another purpose for adjusting the frequency deviation of clock signals, as detailed later, it becomes possible to omit clock signal lines which have been indispensable in the conventional configuration, and thereby, to simplify the signal paths.

Incidentally, when CPU 1113 transmits the data in the synchronized serial data transmission mode, CPU 1113 transmits the load signal, which rises at a time of starting the data transmission, to another CPU equipped in a signal-processing circuit, serving as a destination terminal through the load-signal lines. Incidentally, the load signal is also utilized for synchronizing the clock signals of the other signal-processing circuit.

Further, in signal-processing circuit 1120, clock-generating section 1121 and signal-processing circuit 1120a, driven by the clock signals generated by clock-generating section 1121, are arranged. Further, clock-generating section 1121 comprises oscillator (OSC) 1122 oscillating at a predetermined frequency, CPU 1123 serving as a controlling means, table 1140 for storing the predetermined data, delay chain section 1125 for generating a plurality of delayed signals having different delay times by delaying oscillation signals, outputted from oscillator 1122, in slightly different delay times, synchronizing signal detecting section 1126 for detecting a synchronizing signal from a large number of delayed signals, synchronized switching section 1127 for performing a synchronized switching operation and selector 1128, serving as a selecting means, for selecting a certain delayed signal out of a large number of delayed signals.

Incidentally, when CPU 1123 receives the data in the synchronized serial data transmission mode, CPU 1123 receives the load signal, which rises at a time of starting the data reception, from another CPU equipped in a signal-processing circuit, serving as a sender terminal through the load-signal lines. Accordingly, the load signal is not only utilized for the communicating operation of the serial data, but also utilized for synchronizing the clock signals of signal-processing circuit 1120 with that of signal-processing circuit 1110.

Incidentally, if the sender terminal and the destination terminal are reversed relative to each other, a direction for transmitting the load signal is also reversed. Accordingly, the synchronizing operation of the clock signals is also conducted in the reversed direction.

(B) Synchronizing Signal Detecting Operation:

The signal-controlling apparatus, embodied in the present invention, is characterized in that a plurality of signal-controlling circuits are synchronized each other, corresponding to the load signal. For this purpose, it is desirable that the CPU in each of the plurality of signal-controlling circuits generates pulse signal (hereinafter referred to as a timing signal), having a logic status and width suitable for the synchronizing signal detecting operation performed in the synchronizing signal detecting section and corresponding to the load signal (namely, the phase of which coincides with that of the load signal), though the timing signal could be the load signal itself. In the present specification, a concrete example, in which the synchronizing signal detecting operation is performed by employing the timing signal corresponding to the load signal, will be detailed in the following.

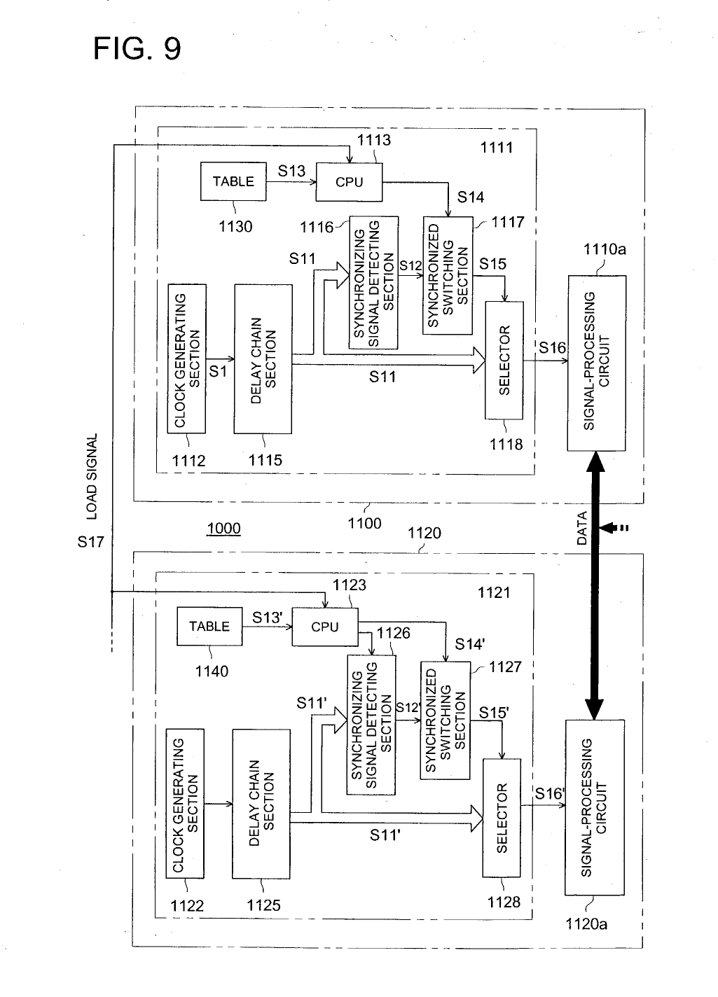

Synchronizing signal-detecting sections 1116, 1126 serve as detecting means for selecting a specific delayed signal, synchronizing with the timing signal corresponding to the load signal and sent from the CPU, out of a group of delayed signals (S11, S11′ in FIG. 9), and for detecting a number of stages (synchronized point) of the selected delayed signal to output a synchronized point information (S12, S12′ in FIG. 9). Incidentally, it is desirable that synchronizing signal-detecting sections 1116, 1126 can output both the first synchronized point information SP1, synchronized with the timing signal at first, and the second synchronized point information SP2, synchronized with the timing signal at second, detecting from the group of delayed signals (S11, S11′ in FIG. 9).

Since there is a possibility that delay times of the plurality of delayed signals outputted from delay chain sections 1115, 1125 can be varied under the influences of the temperature change, etc., the number of delayed signals included within a predetermined and stable time-interval (an interval between a timing signal and its next timing signal) is detected in advance as aforementioned.

By conducting the aforementioned process, even if the delay time of the individual delay cell varies with the temperature change, the overall system of the apparatus cannot be suffered by any influence of them, resulting in an advantageous point of the present invention. Accordingly, it is not necessary to employ expensive parts for the delay cell itself.

(B) Calculation of Compensation Amount:

Each of synchronized switching sections 1117, 1127 outputs a select signal (S5, S5′ in FIG. 1) for designating a specific delayed signal to be selected out of the group of the delayed signals (S1, S1′ in FIG. 1) by finding a synchronized compensation amount based on the synchronized point information (S2, S2′ in FIG. 1) outputted from synchronizing signal-detecting sections 1116, 1126 and the skew information (S3, S3′ in FIG. 1) read by CPU 1113, 1123 from table 1130, 1140.

Incidentally, the “skew information” is equivalent to the “setting data with respect to a synchronizing operation” described in this specification. Further, a term of “skew” is defined as an arriving-time difference occurring when the clock signals are transmitted through plural paths of signal lines. The skew causes such the problems that a plurality of signal-processing circuits cannot be driven just in the same timing of the clock signals, and the reliability of the data-communications between them would be lowered. The more higher the frequency of the clock signals for driving the circuit is raised, the more serious the abovementioned problems become. Further, the occurred delay times are different each other between the data and the clock pulses, and such the differences between the occurred delay times result in deterioration of the reliability of their operations.

In signal-processing circuit 1120, which receives the load signal from signal-processing circuit 1110 through the load-signal transmission line, the received load signal itself has a skew. Accordingly, only by selecting a specific delayed signal, which is synchronized with the received load signal, the selected delayed signal is not necessary synchronized with the original reference pulse signal generated in signal-processing circuit 1110.

To cope with the above problem, data of time differences caused by the skew are stored in advance as skew information in table 1140. Then, CPU 1123 performs the synchronizing operation in the clock-generating section by the load signal, so as to cancel the delay time caused by the skew by referring the skew time included in the skew information.

Now, number of delay stages for compensation F_DELAY can be found by the following equation.

F_{—}DELAY=A≈T×PRD

Where, A: a skew time, T: a time of one period of the delay signal, PRD: a number of synchronized stages.

Incidentally, since the number of delay stages for compensation should be subtracted from the number of delay signals synchronized with the load signal (P1→P2), final number of select stages F_SYNC after performing the skew compensation is defined by the following equation.

When SP1−F DELAY≧0,

F_{—}SYNC=SP1−F_{—}DELAY

while, when SP1−F_DELAY<0,

F_{—}SYNC=SP2−F_{—}DELAY.

Further, by storing an adjusting amount other than the skew mentioned above in table 1140, the compensation corresponding to the adjusting amount will be also conducted.

(D) Pulse Selection, Clock Output:

Each of selectors 1118, 1128 receives a number of select stages included in the select signal (S15, S15′ in FIG. 9) sent from each of synchronized switching sections 1117, 1127 and selects a specific delay signal having a corresponding phase out of the group of the delayed signals (S12, S12′ in FIG. 9) to output it as a clock signal (S16, S16′ in FIG. 9).

(E) Synchronizing Operation by Load Signal

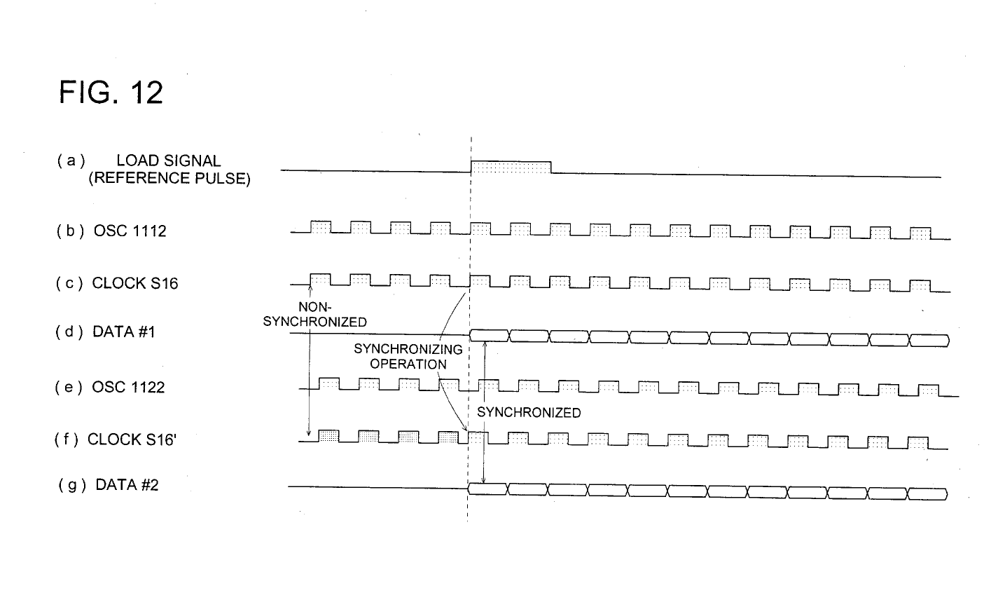

As aforementioned, signal-processing circuits 1110, 1120 are so constituted that the period of the clock signal can be slightly increased or decreased. Further, CPU 1113 equipped in the signal-processing circuit 1110 transmits the load signal (S17 in FIG. 9, line (a) in FIG. 12) to CPU 1123 equipped in the signal-processing circuit 1120 through the load signal transmitting line. Still further, both CPU 1113 and CPU 1123 perform the selecting operation of the delayed signal synchronized with the load signal in each of selectors 1118, 1128 by giving the timing signal, corresponding to the load signal (shown in line (a) of FIG. 12), to the synchronizing signal-detecting section, so as to conduct the synchronizing operation between the clock signals (synchronizing operation shown in line (c) and line (f) of FIG. 12), even if the both oscillators oscillate in different timings relative to each other (shown in line (b) and line (e) of FIG. 12). Accordingly, in the state that signal-processing circuit 1110 and signal-processing circuit 1120 are synchronized with each other corresponding to the load signal, the bilateral data communicating operation (shown in line (d) and line (g) of FIG. 12) and the data processing operation are performed in both signal-processing circuit 1110 and signal-processing circuit 1120.

Since, in this embodiment, the pulse of load signal, serving as a trigger of the bilateral data communicating operation, is transmitted instead of the continuous clock signal itself when performing the synchronizing operation between the signal-processing circuits, the problem of the electromagnetic radiation can be solved. Accordingly, in the signal-processing apparatus having a plurality of signal-processing circuits each of which provided with the clock-generating section, it becomes possible to perform the synchronizing operation between the clock-generating sections of the signal-processing circuits without causing the problem of the electromagnetic radiation.

Further, according to this embodiment, even if electronic circuits, to be driven by the clock signals having the same frequency and phase, are located at positions being separated relative to each other, it becomes possible to perform the synchronizing operation between the clock-generating sections of the signal-processing circuits without causing the problem of the electromagnetic radiation.

(F) Timing of Synchronizing Operation

Further, in case of the same apparatus as shown in FIG. 9 or the system in which separate signal-processing apparatus are coupled each other in a tandem operating mode as shown in FIG. 10, the synchronizing operation is automatically performed at every time when the transmitting/receiving operation of the serial data is performed. Accordingly, there is no need to manually perform any intentional synchronizing operation. Still further, since the synchronizing operation is automatically performed at a time of starting the transmitting/receiving operation of the serial data, the problem of timing deviation of the clock signals or the problem of disturbing interruption, during the serial data transmitting operation or the various signal-processing operations, could be solved.

[Other Embodiments]

Although the digital delay clock adjusting means is employed in the second embodiment described in the foregoing, another type analogue delay means (such as an analogue delay line) can be also employed for this purpose. It is desirable however, that the digital delay clock adjusting means is employed for this purpose rather than the analogue delay means, because of the structural advantage of 1 chip IC circuit, shortened wirings in the 1 chip IC circuit, minimized influence of errors caused by heat and temperature change, controlling easiness, etc.

In the aforementioned second embodiment, the whole configuration of the plurality of signal-processing circuits and the CPUs can be structured by the digital circuits, when each of the signal-processing circuits is structured by the digital delay clock adjusting means. In this configuration, it becomes possible to easily and accurately conduct the synchronizing operation in the clock-generating section of each signal-processing circuit in a digital operating mode. Further, by structuring the whole circuit in a digital circuit, it becomes possible to reduce the manufacturing cost lower than fractions of that when employing a conventional analogue delay line. Still further, by structuring the whole circuit in a 1 chip IC circuit, such as a gate array, etc., the interferences between signals, which have conventionally occurred in the externally coupled analogue delay line, are not generated, resulting in a solution of the signal noise problem.

Further, although the serial data transmission between one terminal and another terminal, both serving as signal-processing circuits, has been described in the aforementioned second embodiment, it is possible to obtain a good result even in the serial data transmission between one terminal to other plural terminals.

Further, although the aforementioned signal-processing apparatus, embodied in the present invention, can be applied for various kinds of apparatus, it would result in very good features to employ it for an image-forming apparatus, such as a copier, a printer and a facsimile device, which has a circuit board for conducting a plurality of processing operations requiring synchronized processing. Still further, since the synchronizing operation is automatically performed at a time of starting the transmitting/receiving operation of the serial data, the problems, such as timing deviations of the clock signals, disturbing interruptions, etc. occurring during the serial data transmitting operation or the various signal-processing operations, could be solved, and therefore, the features of the present invention can be effectively applied for image-forming apparatus. Still further, it is possible to obtain a good result by applying the second embodiment to such a case that a plurality of image-forming apparatus are coupled to each other in a tandem operating mode to operate them in parallel and in a synchronized state.

As described in the foregoing, according to the present invention, the following effects can be attained.

(1) In the first embodiment of the signal-controlling apparatus, the signal-processing circuits are controlled by the data signals, clock signals and reference pulses. When the signal-controlling apparatus are coupled to each other through a synchronized serial interface for bilaterally communicating the data signals in a state synchronized with clock signals, a plurality of signal-processing circuits are coupled to each other with a data communication line through which the data signals are bilaterally communicated between the plurality of signal-processing circuits and a reference pulse communication line through which reference pulses are transmitted, and anyone of the plurality of signal-processing circuits acts as a master circuit, while others act as slave circuits. At first, in a measuring time prior to an operating time, the master signal-processing circuit transmits the reference pulse to the slave signal-processing circuit at intervals of a predetermined time period, while, in the measuring time, the slave signal-processing circuit receives the reference pulse to measure a frequency deviation of clock signals, generated in said clock-generating section, by measuring the interval between the reference pulses with the clock signals generated by the oscillator. Then, in the operating time after the measuring time, the slave signal-processing circuit adjusts the frequency deviation of clock signals, based on the measuring result made in the measuring time. Through the abovementioned process, the clock signals of the slave signal-processing circuits are synchronized with that of the master signal-processing circuit. As a result, clock-signal transmitting lines and the transmission of clock signals between signal-processing circuits are eliminated, and therefore, the problem of electro-magnetic radiation is solved, and further, the problem of the frequency deviation of clock signals is also solved by employing the reference pulse. In other words, since the operation for adjusting the frequency deviation of clock signals are performed in the measuring time without really transmitting the clock signals, it becomes possible to perform the serial data transmitting operation in the operating time without causing the problems of electromagnetic radiation and the frequency deviation of clock signals.

(2) In the first embodiment of the image-forming apparatus, the signal-processing circuits are controlled by the data signals, clock signals and reference pulses. When the image-forming apparatus are coupled to each other through a synchronized serial interface for bilaterally communicating the data signals in a state synchronized with clock signals, a plurality of signal-processing circuits are coupled to each other with a data communication line through which the data signals are bilaterally communicated between the plurality of signal-processing circuits, and anyone of the plurality of signal-processing circuits acts as a master circuit, while others act as slave circuits. At first, in a measuring time prior to an operating time, the master signal-processing circuit transmits the reference pulse to the slave signal-processing circuit at intervals of a predetermined time period, while, in the measuring time, the slave signal-processing circuit receives the reference pulse to measure a frequency deviation of clock signals, generated in said clock-generating section, by measuring the interval between the reference pulses with the clock signals generated by oscillator 1122). Then, in the operating time after the measuring time, the slave signal-processing circuit adjusts the frequency deviation of clock signals, based on the measuring result made in the measuring time. Through the abovementioned process, the clock signals of the slave signal-processing circuits are synchronized with that of the master signal-processing circuit. As a result, clock-signal transmitting lines and the transmission of clock signals between signal-processing circuits are eliminated, and therefore, the problem of electromagnetic radiation is solved, and further, the problem of the frequency deviation of clock signals is also solved by employing the reference pulse. In other words, according to the image-forming apparatus, embodied in the present invention, since the operation for adjusting the frequency deviation of clock signals are performed in the measuring time without really transmitting the clock signals, it becomes possible to perform the serial data transmitting operation in the operating time without causing the problems of electromagnetic radiation and the frequency deviation of clock signals.

(3) In the second embodiment of the signal-controlling apparatus, the signal-processing circuits are controlled by the data signals, clock signals and reference pulses. When the signal-controlling apparatus are coupled to each other through a synchronized serial interface for bilaterally communicating the data signals in a state synchronized with clock signals, the plurality of signal-processing means are coupled to each other with a data communication line through which the data signals are bilaterally communicated between the plurality of signal-processing means and a load-signal communication line through which load signals are transmitted, and anyone of the plurality of signal-processing means transmits the load signals to other signal-processing means, while the others control data transmitting/receiving operations and perform synchronizing operations in the clock-signal generating sections, based on the load signals. As a result, clock-signal transmitting lines and the transmission of clock signals between signal-processing means are eliminated, and therefore, the problem of electromagnetic radiation is solved, and further, the problem of the frequency deviation of clock signals is also solved by employing the load signals for the synchronizing operations.

(4) In the second embodiment of the image-forming apparatus, when the plurality of signal-processing means are controlled by the data signals, clock signals and load signals, and are coupled to each other through the synchronized serial interface for bilaterally communicating the data signals in the state synchronized with the clock signals, the plurality of signal-processing means are coupled to each other with the data communication line through which the data signals are bilaterally communicated between the plurality of signal-processing means and the load signals communication line through which the load signals are transmitted, and anyone of the plurality of signal-processing means transmits the load signals to other signal-processing means, while the others control data transmitting/receiving operations and perform synchronizing operations in the clock-signal generating sections, based on the load signals. As a result, since clock-signal transmitting lines and the transmission of clock signals between signal-processing means provided in the image-forming apparatus are eliminated, it becomes possible to simplify the signal transmitting paths even between the plurality of image-forming apparatus and to conduct the synchronized operations with the serial data transmission in a state of solving the electromagnetic radiation problem caused by the clock signals. Further, the abovementioned invention can be applied to such a case that the image-forming operations are performed between a plurality of image-forming apparatus in a state of synchronizing with each other. In this case, it becomes possible to simplify the signal transmitting paths even between the plurality of image-forming apparatus and to conduct the synchronized operations with the serial data transmission in a state of solving the electromagnetic radiation problem caused by the clock signals.

Disclosed embodiment can be varied by a skilled person without departing from the spirit and scope of the invention.

What is claimed is:

1. A signal-controlling apparatus, which is coupled to another signal-controlling apparatus through a synchronized serial interface for bilaterally communicating data signals in a state synchronized with clock signals, said signal-controlling apparatus comprising:
a plurality of signal-processing circuits, each of which includes a clock-generating section to generate said clock signals;
a data communication line through which said data signals are bilaterally communicated between said plurality of signal-processing circuits; and
a reference pulse communication line through which reference pulses are transmitted from a master signal-processing circuit, being anyone of said plurality of signal-processing circuits, to a slave signal-processing circuit, being another one of said plurality of signal-processing circuits;
wherein, in a measuring time prior to an operating time, said master signal-processing circuit transmits said reference pulses to said slave signal-processing circuit at intervals of a predetermined time period; and
wherein, in said measuring time, said slave signal-processing circuit receives said reference pulse to find a frequency deviation of clock signals, generated in said clock-generating section, by measuring an interval between said reference pulses with clock signals generated in said clock-generating section, and, in said operating time after said measuring time, said slave signal-processing circuit adjusts said frequency deviation of clock signals, based on a result found in said measuring time.

2. The signal-controlling apparatus of claim 1,
wherein said clock-generating section, provided in said slave signal-processing circuit, comprises:
an oscillator to generate original-oscillation signals, having substantially a same frequency as that of said clock signals generated in said master signal-processing circuit;
a delay chain section, including a plurality of delay stages cascaded in a chain, to generate a plurality of delayed signals by delaying said original-oscillation signals outputted from said oscillator in slightly different delay times, and each of said plurality of delayed signals being outputted from each of said plurality of delay stages;
a synchronized-signal detecting section to detect a number of delay stages, which outputs a delayed signal synchronized with a first reference pulse, being one of said reference pulses, and another number of delay stages, which outputs a delayed signal synchronized with a second reference pulse, received next to said first reference pulse; and
a correction-calculating section to count said original-oscillation signals occurring between said first reference pulse and said second reference pulse in a unit of one pulse of said clock signals, and to measure a partial duration time less than one period of said clock signals by referring a result detected by said synchronized-signal detecting section, so as to measure said frequency deviation of clock signals, generated in said clock-generating section provided in said slave signal-processing circuit, in an accuracy of less than one period of said clock signals.

3. The signal-controlling apparatus of claim 2,
wherein said clock-generating section, provided in said slave signal-processing circuit, further comprises:
a selector controlling section to control a selecting operation of said delayed signals outputted by said delay chain section; and
a selector to select a specific delayed signal out of said delayed signals inputted from said delay chain section, based on a command signal outputted from said selector controlling section;
wherein said correction-calculating section finds a adjusting coefficient for adjusting said frequency deviation of said clock signals by comparing a result, of measuring a number of clock signals included in a time between said first reference pulse and said second reference pulse in said accuracy of less than one period of said clock signals, with said predetermined time period between said reference pulses; and
wherein, in said operating time, said selector controlling section controls said selecting operation of said delayed signals, corresponding to said adjusting coefficient and said result detected by said synchronized-signal detecting section, so as to adjust said frequency deviation of said clock signals for every clock pulse in an accuracy of less than one period of said clock signals.

4. The signal-controlling apparatus of claim 3,
wherein each of sections included in said signal-controlling apparatus is composed of digital circuits.

5. The signal-controlling apparatus of claim 3,
wherein each of sections included in said signal-controlling apparatus is composed of digital circuits and said signal-controlling apparatus includes a CPU (Central Processing Unit) serving as a controlling section.

6. An image-forming apparatus, which is coupled to another image-forming apparatus through a synchronized serial interface for bilaterally communicating data signals in a state synchronized with clock signals, said image-forming apparatus comprising:
a plurality of signal-processing circuits, each of which includes a clock-generating section to generate said clock signals;
a data communication line through which said data signals are bilaterally communicated between said plurality of signal-processing circuits; and
a reference pulse communication line through which reference pulses are transmitted from a master signal-processing circuit, being anyone of said plurality of signal-processing circuits, to a slave signal-processing circuit, being another one of said plurality of signal-processing circuits;
wherein, in a measuring time prior to an operating time, said master signal-processing circuit transmits said reference pulses to said slave signal-processing circuit at intervals of a predetermined time period; and
wherein, in said measuring time, said slave signal-processing circuit receives said reference pulse to find a frequency deviation of clock signals, generated in said clock-generating section, by measuring an interval between said reference pulses with clock signals generated in said clock-generating section, and, in said operating time after said measuring time, said slave signal-processing circuit adjusts said frequency deviation of clock signals, based on a result found in said measuring time.

7. The image-forming apparatus of claim 6,
wherein said clock-generating section, provided in said slave signal-processing circuit, comprises:
an oscillator to generate original-oscillation signals, having substantially a same frequency as that of said clock signals generated in said master signal-processing circuit;
a delay chain section, including a plurality of delay stages cascaded in a chain, to generate a plurality of delayed signals by delaying said original-oscillation signals outputted from said oscillator in slightly different delay times, and each of said plurality of delayed signals being outputted from each of said plurality of delay stages;
a synchronized-signal detecting section to detect a number of delay stages, which outputs a delayed signal synchronized with a first reference pulse, being one of said reference pulses, and another number of delay stages, which outputs a delayed signal synchronized with a second reference pulse, received next to said first reference pulse; and
a correction-calculating section to count said original-oscillation signals occurring between said first reference pulse and said second reference pulse in a unit of one pulse of said clock signals, and to measure a partial duration time less than one period of said clock signals by referring a result detected by said synchronized-signal detecting section, so as to measure said frequency deviation of clock signals, generated in said clock-generating section provided in said slave signal-processing circuit, in an accuracy of less than one period of said clock signals.

8. The image-forming apparatus of claim 7,
wherein said clock-generating section, provided in said slave signal-processing circuit, further comprises:
a selector controlling section to control a selecting operation of said delayed signals outputted by said delay chain section; and
a selector to select a specific delayed signal out of said delayed signals inputted from said delay chain section, based on a command signal outputted from said selector controlling section;
wherein said correction-calculating section finds a adjusting coefficient for adjusting said frequency deviation of said clock signals by comparing a result, of measuring a number of clock signals included in a time between said first reference pulse and said second reference pulse in said accuracy of less than one period of said clock signals, with said predetermined time period between said reference pulses; and
wherein, in said operating time, said selector controlling section controls said selecting operation of said delayed signals, corresponding to said adjusting coefficient and said result detected by said synchronized-signal detecting section, so as to adjust said frequency deviation of said clock signals for every clock pulse in an accuracy of less than one period of said clock signals.

9. A signal-controlling apparatus, which is coupled to another signal-controlling apparatus through a serial interface for bilaterally communicating data signals in a state synchronized with clock signals, said signal-controlling apparatus comprising:
a plurality of signal-processing circuits, each of which includes a clock-generating section to generate said clock signals;
a data communication line through which said data signals are bilaterally communicated between said plurality of signal-processing circuits; and
a load signal communication line through which load signals are transmitted from a master signal-processing circuit, being anyone of said plurality of signal-processing circuits, to a slave signal-processing circuit, being another one of said plurality of signal-processing circuits;
wherein, in said slave signal-processing circuit, both a data transmitting/receiving operation and a synchronizing operation for said clock-generating section are conducted on the basis of said load signals transmitted from said master signal-processing circuit.

10. The signal-controlling apparatus of claim 9,
wherein said load signals are periodically transmitted at intervals of a predetermined time period.

11. The signal-controlling apparatus of claim 9,
wherein said clock-generating section, provided in said slave signal-processing circuit, comprises:
an oscillator to generate original-oscillation signals, having substantially a same frequency as that of said clock signals generated in said master signal-processing circuit;
a delay chain section, including a plurality of delay stages cascaded in a chain, to generate a plurality of delayed signals by delaying said original-oscillation signals outputted from said oscillator in slightly different delay times, and each of said plurality of delayed signals being outputted from each of said plurality of delay stages;
a synchronized-signal detecting section to detect a delayed signal synchronized with said load signals; and
a selector to select a specific delayed signal out of said delayed signals inputted from said delay chain section, based on a command signal outputted from said selector controlling section.

12. The signal-controlling apparatus of claim 9,
wherein each of sections included in said signal-controlling apparatus is composed of digital circuits.

13. The signal-controlling apparatus of claim 11, further comprising:
a selector controlling section to perform an arithmetic processing for fine adjustments when selecting said specific delayed signal out of said delayed signals inputted from said delay chain section.

14. The signal-controlling apparatus of claim 11, further comprising:
a storing section to store setting data for said synchronizing operation; and
a controlling section to control each of sections included in said signal-controlling apparatus by referring to said setting data stored in said storing section.

15. The signal-controlling apparatus of claim 11, further comprising:
a data communicating section to receive setting data for said synchronizing operation from an external apparatus; and
a controlling section to control each of sections included in said signal-controlling apparatus by referring to said setting data received through said data communicating section.

16. The signal-controlling apparatus of claim 11, further comprising:
a data inputting terminal to input setting data for said synchronizing operation; and
a controlling section to control each of sections included in said signal-controlling apparatus by referring to said setting data inputted through said data inputting terminal.

17. An image-forming apparatus, which is coupled to another image-forming apparatus through a serial interface for bilaterally communicating data signals in a state synchronized with clock signals, said image-forming apparatus comprising:
a plurality of signal-processing circuits, each of which includes a clock-generating section to generate said clock signals;
a data communication line through which said data signals are bilaterally communicated between said plurality of signal-processing circuits; and
a load signal communication line through which load signals are transmitted from a master signal-processing circuit, being anyone of said plurality of signal-processing circuits, to a slave signal-processing circuit, being another one of said plurality of signal-processing circuits;
wherein, in said slave signal-processing circuit, both a data transmitting/receiving operation and a synchronizing operation for said clock-generating section are conducted on the basis of said load signals transmitted from said master signal-processing circuit.

18. The image-forming apparatus of claim 17,
wherein said load signals are periodically transmitted at intervals of a predetermined time period.

19. The image-forming apparatus of claim 17,
wherein said clock-generating section, provided in said slave signal-processing circuit, comprises:
an oscillator to generate original-oscillation signals, having substantially a same frequency as that of said clock signals generated in said master signal-processing circuit;
a delay chain section, including a plurality of delay stages cascaded in a chain, to generate a plurality of delayed signals by delaying said original-oscillation signals outputted from said oscillator in slightly different delay times, and each of said plurality of delayed signals being outputted from each of said plurality of delay stages;
a synchronized-signal detecting section to detect a delayed signal synchronized with said load signals; and
a selector to select a specific delayed signal out of said delayed signals inputted from said delay chain section, based on a command signal outputted from said selector controlling section.

20. The image-forming apparatus of claim 17,
wherein each of sections included in said signal-controlling apparatus is composed of digital circuits.
